(19) United States
(12) Patent Application Publication
(10) Pub. No.: US 2026/0331779 A1
(43) Pub. Date: Oct. 22, 2026

(54) SYSTEM AND METHOD FOR ELECTROMAGNETIC SIGNAL READOUT ACROSS A RECONFIGURABLE METASURFACE UNIT CELL ARRAY VIA A SUBSTRATE-INTEGRATED WAVEGUIDE (SIW)

(71) Applicant: Dell Products LP, Round Rock, TX (US)

(72) Inventors: Tejinder Singh, Manotick (CA); Navjot Kaur Khaira, Manotick (CA); Harpreet S. Narula, Austin, TX (US)

(73) Assignee: Dell Products LP, Round Rock, TX (US)

(21) Appl. No.: 19/185,883

(22) Filed: Apr. 22, 2025

(51) Int. Cl. H01Q 15/00; H01Q 1/02; H01Q 3/34; H01Q 21/00

(52) U.S. Cl. CPC H01Q 15/0086; H01Q 1/02; H01Q 3/34; H01Q 21/0006

(57) ABSTRACT

A system and method of detecting radiofrequency (RF) signals incident to a surface of a reconfigurable metasurface unit cell array. The reconfigurable metasurface unit cell array includes a plurality of reconfigurable metasurface unit cells that include a plurality of reconfigurable split rings of a phase-changing material that are configured to selectively switch between a conductive state and a dielectric state via a heat pulse controlled by a metasurface hardware controller from a plurality of corresponding refractory heaters. Each unit cell comprises a substrate-integrated waveguide that includes a plurality of RF coupling elements in a shielded chamber in the reconfigurable metasurface unit cell to couple a portion of EM energy from the incident RF signal to report the captured incident RF signal to the metasurface hardware controller. The metasurface hardware controller may then determine how to reconfigure the reflected RF signal direction from the reconfigurable metasurface unit cell array.

### FIELD OF THE DISCLOSURE

The present disclosure generally relates to a reconfigurable metasurface unit cell array. The present disclosure more specifically relates systems and methods for automatically reconfiguring a reconfigurable metasurface unit cell array based accurate detection of radiofrequency signals with a substrate-integrated waveguide integrated in reconfigurable metasurface unit cells to adjust reflected electromagnetic (EM) waves for the radiofrequency signals by the reconfigurable metasurface unit cell array.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used for wireless communications including transmission and reception of radiofrequency data signals via wireless radio systems.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system wirelessly interfacing with a reconfigurable metasurface unit cell array comprising a plurality of reconfigurable metasurface unit cells that each include a substrate-integrated waveguide according to an embodiment of the present disclosure;

FIG. 2 is a block diagram illustrating an information handling system including and operatively coupled to a reconfigurable metasurface unit cell array comprising a plurality of reconfigurable metasurface unit cells that each include a substrate-integrated waveguide according to an embodiment of the present disclosure;

FIG. 3 is an exploded graphic diagram illustrating a perspective view of a reconfigurable metasurface unit cell of a reconfigurable metasurface unit cell array that includes a substrate-integrated waveguide according to an embodiment of the present disclosure;

FIG. 4A is a top view graphic diagram showing a plurality of metasurface reconfigurable split rings of a reconfigurable metasurface unit cell according to an embodiment of the present disclosure;

FIG. 4B is a bottom view diagram showing a plurality of contact pads of a reconfigurable metasurface unit cell according to an embodiment of the present disclosure;

FIG. 5 is graphic diagram of a top view of a plurality of reconfigurable metasurface unit cells of a reconfigurable metasurface unit cell array depicting various activation states of the plurality of unit cells according to an embodiment of the present disclosure;

FIG. 6 is an exploded graphic diagram of a plurality of contact pads for actuation of refractory heaters and activation of radiofrequency (RF) coupling elements in the substrate-integrated waveguide of a reconfigurable metasurface unit cell according to another embodiment of the present disclosure;

FIG. 7 is an exploded graphic diagram of a substrate-integrated waveguide with a plurality of RF coupling elements for a reconfigurable metasurface unit cell according to an embodiment of the present disclosure;

FIG. 8 is a graphic diagram of directionality of various emission states of a reconfigurable metasurface unit cell array operated by a digital-to-analog converter (DAC) and a field programmable gate array (FPGA) or other metasurface hardware controller according to an embodiment of the present disclosure; and

FIG. 9 is a block diagram of a method of detecting radiofrequency signals with a substrate-integrated waveguide for determination of differential phase measurements across a reconfigurable metasurface unit cell array according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid wireless data transmission and communication between multiple devices. Devices may include wirelessly enabled information handling systems, access point devices, or any computing device, such as internet of things (IoT) devices that are wirelessly capable. As data transmission requirements increase, the electromagnetic (EM) wave radiofrequencies (e.g., 5G technologies using 20 to 50 GHz wireless signals or WiFi 6 signals at 2.4 GHz, 5 GHz or even 6 GHz) used to transmit these ever-increasing amounts of data have smaller wavelengths with shortened reach and may benefit from extended range such as to reach around radiofrequency barriers such as walls. However, the ability to penetrate walls and building structures as well as transmit around these relatively large structures may be limited with such wireless systems. Additionally, material properties of these buildings and other structures effect reflection from, and transmission of, EM waves through building materials and on the absorption of EM wave energy in those materials, which gives rise to attenuation of the EM signal. Other EM wave-inhibiting mechanisms include diffraction from the edges of materials and scatter from rough edges also that exist in radiofrequency environments such as rooms within a building. Further, most buildings behave as lossy dielectrics as building materials as well as occasionally conductive material that further inhibit or scatter EM wave propagation. Further, with the advent of massive multiple input multiple output (MIMO) wireless technologies, a group of antennas at both the transmitting device and receiving device may provide high spectral and energy efficient wireless communication systems but may utilize these high-frequency, low wavelength radiofrequency signals.

In an embodiment of the present disclosure, a series of thin surfaces or panels can be installed on building surfaces or other surfaces within a radiofrequency environment that may be used to steer these EM waves and expand wireless range or signal quality. Some of these surfaces may include metasurface unit cells in arrays referred to as metasurface arrays, metasurface unit cell arrays, or reconfigurable metasurface unit cell arrays herein. Further, embodiments of the present disclosure may include reconfigurable intelligent surfaces (RISs) or “reconfigurable metasurfaces” or “reconfigurable metasurface unit cell arrays” that include one or more resonant structures designed to reflect EM waves of the radiofrequency signals. In some embodiments, the resonant structures include portions with engineered materials that have properties to allow for dynamic reconfigurability of those portions of resonant structures of the reconfigurable metasurface unit cells in embodiments of the present disclosure. These reconfigurable metasurfaces are crafted and adjusted with a control system to manipulate EM waves in ways that non-reconfigurable metasurface unit cells cannot, thereby often achieving effects control over directionality of reflection and redirection of EM waves of the radiofrequency signals with gain, as well as negative refraction for reducing EM wave levels in null zones, in various embodiments of the present disclosure.

The reconfigurable metasurfaces of embodiments of the present disclosure may be used within current infrastructures having radiofrequency environments within, for example, office settings or home settings where radiofrequency data communication could benefit from these reconfigurable metasurfaces relaying EM wave transmissions around corners, into various office spaces, and/or into various rooms. In some examples of reconfigurable unit cells, the use of PIN diodes and varactor diodes for reconfigurability causes these metasurfaces to have high losses, parasitic effects, and limited phase tunability. Further, these components also complicate soldering and biasing in dense metasurface arrays thereby reducing performance and scalability and ability to function as described in embodiments herein due to power requirements or size limitations. Accordingly, such metasurfaces require continuous power supply increasing the power consumption associated with the use of the metasurfaces. A more efficient, scalable, and precisely integrated reconfigurable metasurface is needed.

To address these and other issues, the present specification describes a reconfigurable metasurface unit cell array to manipulate reflection of electromagnetic (EM) waves for radiofrequency signals. The reconfigurable metasurface may include a plurality of reconfigurable metasurface unit cells formed across the surface of the reconfigurable metasurface. In an embodiment, each reconfigurable metasurface unit cell may include a first metasurface reconfigurable split ring, a second metasurface reconfigurable split ring, and a third metasurface reconfigurable split ring as well as a conductive center node and a conductive outer ring. It is appreciated that any number of metasurface reconfigurable split rings may be formed into the reconfigurable metasurface unit cell, and the present specification also contemplates other form factors for metasurface reconfigurable split rings, for example differing shapes other than a rings, of each of the reconfigurable metasurface unit cells. In an embodiment, the metasurface reconfigurable split rings may be made of a phase change material that, when heated, changes from a first amorphous state to a second crystalline state, or vice-versa. Thus, when a temporary amount heat, such as a heat pulse, is applied to each of the metasurface reconfigurable split rings via corresponding refractory heaters, individually, the phase change material may switch between a high resistance dielectric state to a low resistance conductive state or back again. Changing a selection of metasurface reconfigurable split rings between a conductive state and a dielectric state changes the operation of the reconfigurable metasurface unit cell between the conductive center node and conductive outer ring to adjust EM wave reflection directionality via phase-shift adjustments at given reconfigurable metasurface unit cells according to embodiments herein. In an embodiment, these phase change materials may include, for example, geranium telluride (GeTe), antimony telluride (SbTe), chalcogenide (GeSbTe), and the like. Application of heat may be applied for a short duration, or heat pulses, to switch the phase of these phase change materials back and forth between the high resistance dielectric state to the low resistance conductive state.

In an embodiment, each reconfigurable metasurface unit cells may include a substrate-integrated waveguide (SIW) that includes a plurality of radiofrequency (RF) coupling elements to capture a portion of EM energy created from the EM wave incident to the metasurface reconfigurable split ring. With the RF coupling elements in the SIW embedded in a reconfigurable metasurface unit cells, this EM energy may be detected and sent to a centralized metasurface hardware controller on the reconfigurable metasurface unit cell array and processed. In an embodiment, the centralized metasurface hardware controller may execute machine-readable code instructions of a metasurface adaptive wireless beamforming system module to detect differential phase measurements via the RF coupling elements of SIWs across the reconfigurable metasurface unit cell array. The output from execution of the metasurface adaptive wireless beamforming system module is used by centralized metasurface hardware controller to cause one or more heat pulses to be provided to the first refractory heater, second refractory heater, and third refractory heater so that the first metasurface reconfigurable split ring, the second metasurface reconfigurable split ring, and third metasurface reconfigurable split ring may be used to reconfigure the electromagnetic reflective properties of one or more reconfigurable metasurface unit cells. This is done to reconfigure the reflected EM wave direction or gain as reflected across the reconfigurable metasurface unit cell array.

Thus, the presently-described reconfigurable metasurface unit cell array of embodiments herein is real-time configurable and can optimize signal direction and phase continuously with execution of the metasurface adaptive wireless beamforming system module to respond to a dynamic wireless environment. The switching time of the phase change material between amorphous states and crystalline states of the reconfigurable metasurface unit cell of embodiments herein is in nanoseconds resulting in the reconfiguration time of the reconfigurable metasurface unit cell array being completed within a sub-millisecond timeframe. Still further, the reconfigurable metasurface unit cell array of embodiments herein is energy efficient with the power only being required intermittently during the reconfiguration phase when the first refractory heater, the second refractory heater, or the third refractory heater are actuated to pulse heat the reconfigurable metasurface controller requires low power from a PMU and power source. Once the appropriate refractory pattern is achieved, the phase change materials retain their state without the need for ongoing power applied. The reconfigurable metasurface unit cell array of embodiments herein is also more easily scalable via use of the integrated first refractory heater, the second refractory heater, the third refractory heater, or other refractory heaters as needed in a network among the plurality of reconfigurable metasurface unit cells in any scalable array size. Complication of forming the reconfigurable metasurface unit cells is minimal as is the power requirements for operation.

Additionally, with the inclusion of the SIW into each unit cell the physical size of the reconfigurable metasurface unit cell array is reduced and it shields the RF coupling elements from outside EM waves providing for a more accurate detection of the EM waves of radiofrequency signals incident on the reconfigurable metasurface unit cell. Indeed, external waveguides have been used for signal coupling in other network devices, but these approaches tend to be bulky, introduce additional signal loss, and fail to maintain the compactness required for modern applications. Additionally, fixed metasurface designs do not offer the dynamic tunability needed for real-time signal adaptation thereby making these other fixed metasurfaces less effective in variable environments. With the inclusion of the substrate-integrated waveguides into the unit cells and the execution of the metasurface adaptive wireless beamforming system module described here, these issues are alleviated.

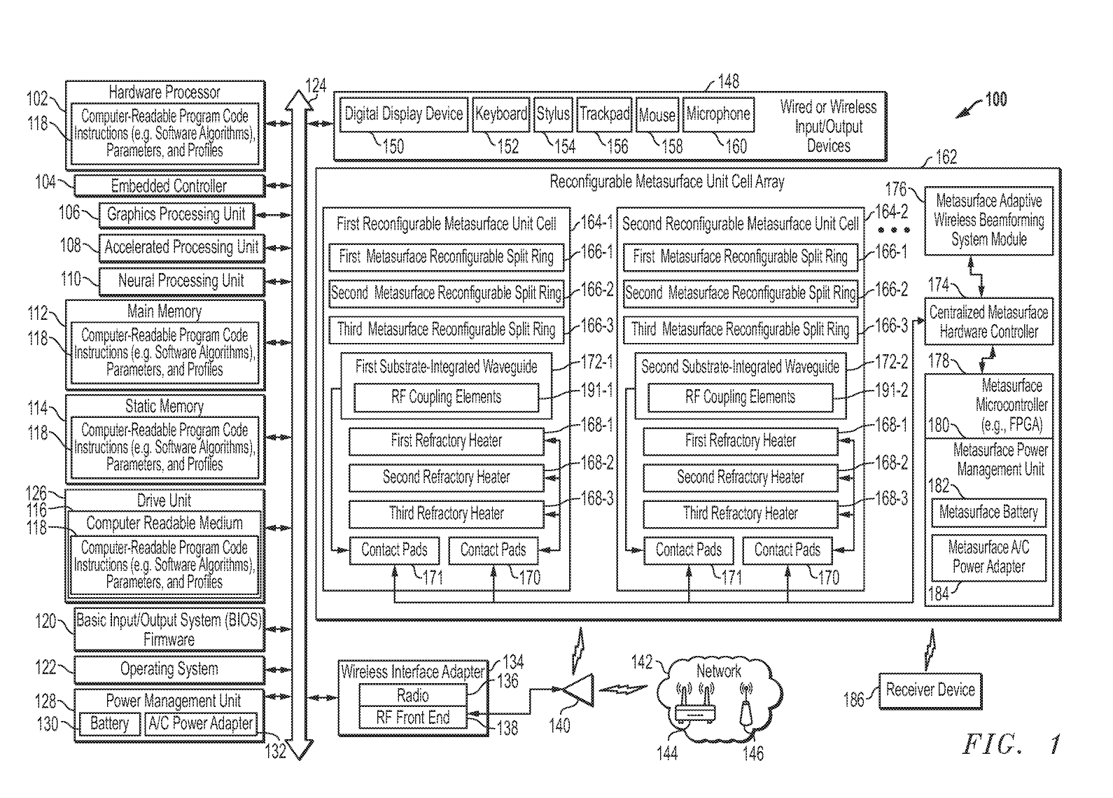

Turning now to the figures, FIG. 1 illustrates an information handling system 100 similar to the information handling systems according to several aspects of the present disclosure that may operate as a source or target radiofrequency device for use with the reconfigurable metasurfaces of the embodiments of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Machine-readable code instructions stored in main memory 112 (e.g., RAM) may be accessible by hardware processing resources using that main memory 112. Machine-readable program code instructions stored in static memory 114, main memory 112, or drive unit 126 may be involved in invoking such machine-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine-readable program code instructions (e.g., software algorithms) parameters, and profiles 118 that may operate on servers or systems, remote data centers, or on-box in individual client information handling systems according to various embodiments herein. In some embodiments, it is understood any or all portions of machine-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute machine-readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with machine-readable medium 116 storing machine-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or with other wireless information handling systems in a radiofrequency environment.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134 such as within the radiofrequency environment of embodiments herein. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via enhanced radiofrequency propagation with reflection using the reconfigurable metasurface unit cell array 162. In other embodiments, the reconfigurable metasurface unit cell array 162 may operate to reflect EM waves of radiofrequency signals between other receiver devices 186 or an AP 144 or base station 146 within a radiofrequency environment in embodiments herein. For example, the receiver device 186 may be a 100 other device and may include the AP 144, the base station 146, or any other computing device described herein. Additionally, the information handling system and receiver device 186 may be capable of transmitting wireless data using, for example, radiofrequency signals in EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of relaying these types of mm waves. In an embodiment, the reconfigurable metasurface unit cell array 162 may be operatively coupled to a surface on the information handling system 100. In this embodiment, a power management unit (PMU) 128 of the information handling system 100 may provide power to the reconfigurable metasurface unit cell array 162. In another embodiment, the reconfigurable metasurface unit cell array 162 may be a standalone device operatively coupled to a surface within a radiofrequency environment with power being provided to the reconfigurable metasurface unit cell array 162 via a metasurface PMU 180 that includes its own metasurface battery 182 and metasurface A/C power adapter to provide this power.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes machine-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a machine-readable medium that includes machine-readable program code instructions, parameters, and profiles 118 or receives and executes machine-readable program code instructions, parameters, and profiles 118 responsive to a propagated signal, so that a hardware device connected to a network 142 may communicate voice, video, or data over the network 142. Further, the machine-readable program code instructions, parameters, and profiles 118 may be transmitted or received over the network 142 via the network interface device or wireless interface adapter 134.

The information handling system 100 or a reconfigurable metasurface unit cell array 162 may include a set of machine-readable program code instructions, parameters, and profiles 118 that may be executed to cause the computer system to perform any one or more of the methods or computer-based functions disclosed herein. For example, the machine-readable program code instructions of a metasurface adaptive wireless beamforming system module may be executed by a hardware processor 102, GPU 106, EC 104, APU 108, NPU 110, or any other hardware processing resource as well as by a metasurface controller 178, such as an FPGA according to embodiments herein. In other examples, machine-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine-readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a machine-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain machine-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain machine-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the machine-readable medium is shown to be a single medium, the term “machine-readable medium” includes a single medium or multiple media, such as a centralized or distributed database, and/or associated caches and servers that store one or more sets of machine-readable code instructions. The term “machine-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the machine-readable medium can include a solid-state memory such as a memory card or other package that houses one or more non-volatile read-only memories. Further, the machine-readable medium can be a random-access memory or other volatile re-writable memory. Additionally, the machine-readable medium can include a magneto-optical or optical medium, such as a disk or tapes or other storage device to store information received via carrier wave signals such as a signal communicated over a transmission medium. Furthermore, a machine-readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a machine-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may operatively communicate with a receiver device 186 (e.g., another information handling system, an AP 144, a base station 146, etc.) for facilitating radiofrequency signal communications between receiver devices 186 (e.g., other information handling systems), an AP 144, or base station 146 via an intermediary-placed reconfigurable metasurface unit cell array 162 in a radiofrequency environment. This reconfigurable metasurface unit cell array 162 may be configured to relay or otherwise reflect wireless EM waves transmitted from the information handling system 100 and may extend the wireless range or improve signal of the information handling system 100 in communications with a target wireless receiver device 178. Again, these EM waves may include any type of EM wave including low-band, mid-band, or high-band millimeter-wave EM waves. These may include 600-900 MHz, 1.7-6 GHz, and 24-47 GHz, among other frequencies.

The reconfigurable metasurface unit cell array 162 may include a plurality of reconfigurable metasurface unit cells, such as the first reconfigurable metasurface unit cell 164-1 and a second reconfigurable metasurface unit cell 164-2 is shown in FIG. 1. It is appreciated that the reconfigurable metasurface unit cell array 162 may contain any number of addressable reconfigurable metasurface unit cells 164-1, 164-2. In one example embodiment, the reconfigurable metasurface unit cell array 162 may contain two-hundred and fifty-six reconfigurable metasurface unit cells 164-1, 164-2 arranged in rows and columns in a sixteen-by-sixteen array. It is appreciated that the reconfigurable metasurface unit cell array 162 may include any plurality of reconfigurable metasurface unit cells 164-1, 164-2 in any arrangement of those unit cells 164-1, 164-2. As described herein, the addressable reconfigurable metasurface unit cells 164-1, 164-2 within the reconfigurable metasurface unit cell array 162 may be used to, in real-time, to reconfigure its reflective properties and phase-shift to incident radiofrequency signals across the addressable reconfigurable metasurface unit cells 164-1, 164-2 to control the refection and steering of incoming EM waves from a transmitting source (e.g., the wireless antenna 140 of the wireless interface adapter 134 of the information handling system 100) and reflection of those EM waves of a radiofrequency signal to a receiver device 178 according to embodiments herein.

In an embodiment, each of the addressable reconfigurable metasurface unit cells 164-1, 164-2 may include a first metasurface reconfigurable split ring 166-1, a second metasurface reconfigurable split ring 166-2, and a third metasurface reconfigurable split ring 166-3 which are reconfigurable as to conductive or dielectric state. In an embodiment, each of the metasurface reconfigurable split rings 166-1, 166-2, 166-3 may be made of a non-volatile phase change material and a conductive bridge to complete each split ring. This phase change material may include, for example, germanium telluride (GeTe), antimony telluride (SbTe), or chalcogenide (GeSbTe) among other similar non-volatile phase change materials. The non-volatile phase change material of the metasurface reconfigurable split rings 166-1, 166-2, 166-3 may have two distinct states: an amorphous state and a crystalline state. In an embodiment, when the non-volatile phase change materials are in an amorphous state, the metasurface reconfigurable split rings 166-1, 166-2, 166-3 have a high resistance for a dielectric state. In an embodiment, when the non-volatile phase change materials are in a crystalline state, the metasurface reconfigurable split rings 166-1, 166-2, 166-3 may have a low resistance for a conductive state. In an embodiment, switching between the amorphous state and the crystalline state may be achieved via application of thermal energy from one of a plurality of refractory heater rings that, in an embodiment, includes a first refractory heater 168-1, a second refractory heater 168-2, and a third refractory heater 168-3 corresponding to each metasurface reconfigurable split ring 166-1, 166-2, 166-3 makes them addressable as described herein. In an embodiment, the non-volatile phase change materials may hold a state as long as it is not actuated with another heat pulse to transition to the alternate state as either the amorphous state or the crystalline state.

In an embodiment, each of the metasurface reconfigurable split rings 166-1, 166-2, 166-3 may be selectively switched from a conductive state to an dielectric state in order to modify constructive and/or destructive interference patterns of the addressable metasurface reconfigurable split rings 166-1, 166-2, 166-3 with the center conductive node and outer conductive ring across plural addressable reconfigurable metasurface unit cells 164-1, 164-2. This modification of constructive and/or destructive interference by phase-shifts across the plural addressable reconfigurable metasurface unit cells 164-1, 164-2 on the incoming EM wave thereby reflectively steers the EM wave in a specific direction such as in the direction of the receiver device 178. With the use of the constructive and/or destructive interference, any number of EM wave beam directions may be created that may be used to increase the feed distance of the EM wave beams in order to expand radiofrequency signal range or focus the directionality of the EM wave beams for the radiofrequency signals in a radiofrequency environment. In an embodiment, the directionality and feed distance of the EM wave beams may be changed (e.g., the array of addressable reconfigurable metasurface unit cells 164-1, 164-2 may be reconfigured) within sub-milliseconds such that data may be transmitted to various different locations within a radiofrequency environment area.

As described in embodiments herein, each of the addressable reconfigurable metasurface unit cells 164-1, 164-2 may include a first refractory heater 168-1, a second refractory heater 168-2, and a third refractory heater 168-3 to, each, selectively apply heat pulses to the first metasurface reconfigurable split ring 166-1, the second metasurface reconfigurable split ring 166-2, and the third metasurface reconfigurable split ring 166-3, respectively. In an embodiment, each of the refractory heaters 168-1, 168-2, 168-3 may be made of tungsten (W). In an embodiment, the first metasurface reconfigurable split ring 166-1, the second metasurface reconfigurable split ring 166-2, and the third metasurface reconfigurable split ring 166-3 are formed into a first layer with the first refractory heater 168-1, the second refractory heater 168-2, and the third refractory heater 168-3 formed into a second layer and electrically insulated. In an embodiment, the first layer is separated from the second layer by a dielectric layer made of, for example, silicon nitride (SiNx) or aluminum nitride (AlN). This dielectric layer may act as an electric insulator that prevents the flow of electric current from the refractory heaters 168-1, 168-2, 168-3 but be thermally conductive.

In an embodiment, each of the refractory heaters 168-1, 168-2, 168-3 are operatively coupled to a contact pad 170. The contact pads 170 may serve as a contact pad through which a metasurface PMU 180, as controlled with metasurface controller 178 may address and provide power to each of the refractory heaters 168-1, 168-2, 168-3 through refractory heater metal interconnects to generate heat pulses for each of the addressable respective reconfigurable metasurface unit cells 164-1, 164-2. In an embodiment, additional layers may be formed below the refractory heaters 168-1, 168-2, 168-3. In an embodiment, these layers may include an dielectric substrate layer made of, for example, high-temperature reusable surface insulation (HRSI), aluminum oxide (Al₂O₃), glass, or printed circuit board among others placed below the second layer. These layers may be thermally insulative.

In an embodiment, a metallization layer used as a radio frequency (RF) ground may be placed below the dielectric substrate layer and may be made of copper or other metal. As described herein, this metallization layer may serve as a top surface of a substrate-integrated waveguide 172-1, 172-2 formed within substrate layering of each of the metasurface unit cells 164-1, 164-2 of the reconfigurable metasurface unit cell array 162. FIG. 1 shows a single substrate-integrated waveguide 172-1, 172-2 for each metasurface unit cell 164-1, 164-2 and the present specification contemplates that a substrate-integrated waveguide 172-1, 172-2 may be formed into any number of metasurface unit cells 164-1, 164-2 arranged within the reconfigurable metasurface unit cell array 162.

The substrate-integrated waveguides 172-1, 172-2 may be used to interact with incoming microwave signals generated from the RF signals incident to the metasurface reconfigurable split rings 166-1, 166-2, 166-3 and radiated through to the nearby refractory heaters 168-1, 168-2, 168-3. The EM waves of the RF signals are captured by the nearby refractory heaters 168-1, 168-2, 168-3 and down the length of the individual metal refractory heater via interconnects through the substrate layers that operatively couple the refractory heaters 168-1, 168-2, 168-3 to the contact pads 170 as described herein. The substrate-integrated waveguides 172-1, 172-2 are bounded top and bottom by metal or other conductive plates connected with a series of closely spaced shielding interconnect vias between the top metal plate and the bottom metal plate to form an enclosed, shielded waveguide space within the substrate layering through which the . In a specific embodiment, each of the substrate-integrated waveguides 172-1, 172-2 may each include one or more RF coupling elements 191-1, 191-2 that detect these incoming microwave signals within the shielded chamber of the substrate-integrated waveguides 172-1, 172-2 from the refractory heater metal interconnects passing through a shielded chamber of the substate-integrated waveguides 172-1, 172-2. The substrate-integrated waveguides 172-1, 172-2 may capture the microwave signals via the one or more RF coupling elements 191-1, 191-2 and route the captured sample of the incident RF signal through their own coupling element metal interconnects to dedicated contact pads 171 for signal capture. These captured incident RF signals may be passed from the dedicated signal capture contact pads 171 to a centralized metasurface hardware controller 174 for use to determine how to modify a phase profile across the reconfigurable metasurface unit cell array 162 via manipulation of each metasurface reconfigurable split rings 166-1, 166-2, 166-3 via the refractory heaters 168-1, 168-2, 168-3 of one or more reconfigurable unit cells 164-1, 164-2 as described herein.

In an embodiment, the centralized metasurface hardware controller 174 may execute machine readable code instructions of a metasurface adaptive wireless beamforming system module 176. Execution of the metasurface adaptive wireless beamforming system module 176 the centralized metasurface hardware controller 174 may detect differential phase measurements across the reconfigurable metasurface unit cell array 162 and provide signal output to provide a voltage pulse to addressable contact pads for a heat pulse to the refractory heaters 168-1, 168-2, 168-3 to reconfigure the electromagnetic reflective properties of one or more reconfigurable metasurface unit cells 164-1, 164-2 of the reconfigurable metasurface unit cell array 162 to reconfigure the reflected EM wave direction. In an embodiment, the centralized metasurface hardware controller 174 determine the output from the metasurface adaptive wireless beamforming system module 176 and generate instructions for a metasurface microcontroller 178 (e.g., field-programmable gate array (FPGA)) to direct a metasurface power management unit (PMU) 178 to send voltages to addressable contact pads for heat pulses at the refractory heaters 168-1, 168-2, 168-3 to manipulate the phase change materials of the metasurface reconfigurable split rings 166-1, 166-2, 166-3 as described herein. These voltages for heat pulses may be provided via a metasurface battery 182 and/or metasurface A/C power adapter 184.

Thus, the substrate-integrated waveguides 172-1, 172-2 may dynamically improve the precision and accuracy of the reflected RF signal while also maintaining compactness of the reconfigurable metasurface unit cell array 162. In other embodiments, the substrate-integrated waveguides 172-1, 172-2 may capture incident RF signals with added precision of a shielded chamber for other purposes such as signal analysis, application of a tunable phase delay circuit or amplitude attenuator, or other purposes. In an embodiment, detecting the differential phase measurements by execution of the metasurface adaptive wireless beamforming system module 176 by the centralized metasurface hardware controller 174 across the surface of the reconfigurable metasurface unit cell array 162 may provide enhanced signal characterization by analyzing phase disparities and variable coupling strength between the various elements within each of the metasurface unit cells 164-1, 164-2. Even further, the use of the substrate-integrated waveguides 172-1, 172-2 in each metasurface unit cell 164-1, 164-2 allows for real-time, dynamic tuning of the reconfigurable metasurface unit cell array 162 response to incoming RF signals using adjustable voltage pulses to the refractory heaters 168-1, 168-2, 168-3 in order to dynamically switch the metasurface reconfigurable split rings 166-1, 166-2, 166-3 from a conductive state to a dielectric state or vice versa where needed and indicated by the metasurface adaptive wireless beamforming system module 176.

In an embodiment, another dielectric layer made of, for example, silicon dioxide (SiO₂) may be placed below the lower conductive plate of the substrate-integrated waveguides 172-1, 172-2 and above the contact pads 170. Thus, in an embodiment, a number of vias are formed through the dielectric substrate layer with the metallization layers/substrate-integrated waveguides 172-1, 172-2 being isolated from each other. Additionally, the dielectric layer placed below the refractory heaters 168-1, 168-2, 168-3 prevent contact between the substrate-integrated waveguide 172-1, 172-2/metallization layer while the contact pads 170 are still operatively coupled to the refractory heaters 168-1, 168-2, 168-3 via the one or more metal refractory heater interconnect vias.

In an embodiment, each of the reconfigurable metasurface unit cells 164-1, 164-2 may include other structures used to redirect transmitted EM waves and beam steer those EM waves in a desired direction. In an example embodiment, the reconfigurable metasurface unit cells 164-1, 164-2 may each include a non-reconfigurable metal fixed outer ring formed around the metasurface reconfigurable split rings 166-1, 166-2, 166-3 as the unit cell resonant structures described herein. The non-reconfigurable metal fixed outer ring may form a passive conductive ring such that it does not require power from the metasurface PMU 180 to maintain its characteristics to contribute to the redirection of the transmitted EM waves and beam steering of those EM waves in a desired direction. In an embodiment, along with the non-reconfigurable metal fixed outer ring, each of the non-reconfigurable metal fixed split ring unit cells 164-1, 164-2 may also include a non-reconfigurable metal fixed center node formed within each of the first metasurface reconfigurable split ring 166-1 of each reconfigurable metasurface unit cell 164-1, 164-2 to also act as a passive conductive dot or pad as another of the resonant structures such that it does not require power from the metasurface PMU 180 to maintain its characteristics to contribute to the redirection of the transmitted EM waves and beam steering of those EM waves in a desired direction.

As described herein, the reconfigurable metasurface unit cell array 162 may be operatively coupled to a metasurface PMU 180 and controlled via a metasurface controller 178 that may be a field programmable gate array (FPGA) circuit microchip or other hardware controller at the reconfigurable metasurface unit cell array 162. Like the PMU 128 of the information handling system 100, the metasurface PMU 180 may include control from the metasurface controller 178 to provide power to each of the refractory heaters 168-1, 168-2, 168-3 for triggered heat pulses via one or a combination of both a metasurface battery 174 and metasurface A/C power adapter 176. In an embodiment, the power needed to operate the reconfigurable metasurface unit cell array 162 may be low such that the metasurface battery 174 may be sufficient to pulse heat to the individual refractory heaters 168-1, 168-2, 168-3 in order to switch the metasurface reconfigurable split rings 166-1, 166-2, 166-3 from an amorphous state to a crystalline state or vice versa.

By switching each of the metasurface reconfigurable split rings 166-1, 166-2, 166-3 between the amorphous state and the crystalline state, the reconfigurable metasurface unit cell array 162 may be configured to redirect transmitted EM waves and beam steer those EM waves in a desired direction and may be controlled via the metasurface controller 178. Additionally, because the heating of the phase change material of the metasurface reconfigurable split rings 166-1, 166-2, 166-3 can be achieved by applying thermal energy such as a pulse with a certain amplitude and width (on the order of nanoseconds) through the electrically insulated high-speed, refractory heaters 168-1, 168-2, 168-3, the constant application of power is not needed thereby reducing the need for a dedicated power source. Indeed, in some embodiments, these phase change materials of the metasurface reconfigurable split rings 166-1, 166-2, 166-3 hold their states as long as it is not actuated with another heat pulse to change to the other crystalline or amorphous phase.

In an embodiment, the reconfigurable metasurface unit cell array 162 may be coupled to an outer surface of the information handling system 100, for example the outer surface of a display chassis of a laptop or table style information handling system 100, such that the reconfigurable metasurface unit cell array 162 may be used to relay incoming EM waves radiofrequency signals to other locations. These other locations may be locations within a radiofrequency environment such as towards other information handling systems such as target receiver devices 178 or to a low throughput zone within the environment from a source radiofrequency signal location such as an AP 144 or base station 146. By allowing the reconfigurable metasurface unit cell array 162 placed on the information handling system 100 to act as an EM wave reflection relay point, the radiofrequency environment that the information handling system 100 is within may be capable of transmitting those high frequency EM waves around corners and across larger distances with effective RSSI radiofrequency signals. In an embodiment, the information handling system 100 may be a laptop-type information handling system 100 and the reconfigurable metasurface unit cell array 162 may be coupled to a surface of the A-cover of the lid or top of a display panel chassis of the information handling system 100 such that, when opened, the information handling system 100 may present a flat surface for the reconfigurable metasurface unit cell array 162 to redirect incoming EM waves to those locations within the radiofrequency environment described herein.

It is appreciated, however, that the reconfigurable metasurface unit cell array 162 may act as a standalone device separate from the information handling system 100 as shown in FIG. 1. In this example embodiment, the reconfigurable metasurface unit cell array 162 may relay or otherwise reflect incoming RF signals within an RF environment using its own power source as described in connection with the metasurface PMU 180.

In the example embodiment where the reconfigurable metasurface unit cell array 162 is operatively coupled to the information handling system 100, the user may move the information handling system 100 such that the orientation of the reconfigurable metasurface unit cell array 162 has changed. This may a result of the user altering the orientation of the information handling system 100 by adjusting the lid portion of the information handling system 100 relative to the base portion, changing the angle of the base portion relative to a previous location, or generally moving the location of the information handling system 100 within the environment. Because the location of the reconfigurable metasurface unit cell array 162 has changed, the current orientation and angle of the beam emitted from the reconfigurable metasurface unit cell array 162 no longer is directed towards another information handling system, such as target receiver device 186, or towards the low throughput zone from a radiofrequency signal source such as AP 144 or a base station 146. The reconfigurable metasurface unit cell array 162 may, in an embodiment, change the direction and magnitude of the reflected EM beam by correcting for those changes in position and location of the information handling system 100 and, accordingly, the reconfigurable metasurface unit cell array 162. In an embodiment, the hardware processor 102 of the information handling system 100 may execute machine-readable program code instructions of metasurface adaptive wireless beamforming system module 176 along with the centralized metasurface hardware controller 174 and metasurface microcontroller 178 to determine and make automatic adjustments to the reconfigurable metasurface unit cell array 162 according to embodiments herein. Execution of the machine-readable program code instructions of the metasurface adaptive wireless beamforming system module 176 causes reconfiguration of the electromagnetic reflective properties of the reconfigurable metasurface unit cell array 162 to reconfigure a reflected EM waves of radiofrequency signals towards a low throughput zone within the radiofrequency environment or towards other receiver devices 186.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

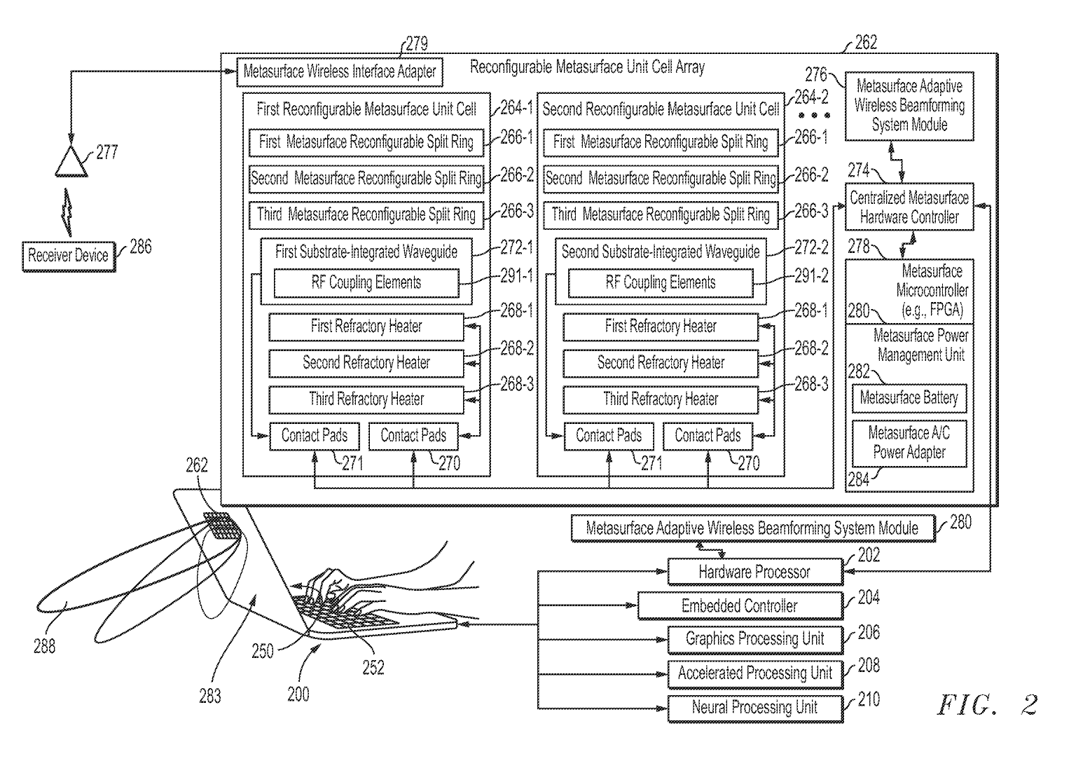

FIG. 2 is a block diagram illustrating an information handling system 200 including and operatively coupled to a reconfigurable metasurface unit cell array 262 comprising a plurality of reconfigurable metasurface unit cells 264-1, 264-2 that each include a substrate-integrated waveguide 272-1, 272-2 according to an embodiment of the present disclosure. FIG. 2 shows the information handling system 200 as a laptop-type information handling system 200 that may include a digital display device 250 and a keyboard 252 as an output and input device, respectively. The laptop-type information handling system 200 allows for the operative coupling of the reconfigurable metasurface unit cell array 262 to the information handling system 200 on, unlike the example embodiment shown in FIG. 1, a surface of the lid portion or A-cover 283 of a display chassis of the information handling system 200. In an embodiment, the information handling system 200 may be operatively coupled to the reconfigurable metasurface unit cell array 262 and the centralized metasurface hardware controller 274, whether standalone or installed at the information handling system 100, via a wireless interface adapter, radio, RF front end, and wireless antenna interfacing with a metasurface wireless interface adapter 279 and metasurface wireless antenna 277. Additionally, or alternatively, the information handling system 200 may be operatively coupled to the reconfigurable metasurface unit cell array 262 and the metasurface controller 278 via a hardware connection such as a wired connection 276 passing through the A-cover 283 in some embodiments. In this embodiment, the PMU (e.g., 128, FIG. 1) of the information handling system 200 may provide power to the reconfigurable metasurface unit cell array 262 instead of the reconfigurable metasurface unit cell array 262 using a metasurface PMU 280 and separate power source (e.g., 182, FIG. 1).

As described herein, the information handling system 200 may operatively communicate with a receiver device 286 (e.g., another information handling system, an AP 244, a base station 246, etc.) for facilitating radiofrequency signal communications between receiver devices 286 (e.g., other information handling systems), an AP, or base station via an intermediary-placed reconfigurable metasurface unit cell array 262 in a radiofrequency environment. This reconfigurable metasurface unit cell array 262 may be configured to relay or otherwise reflect wireless EM waves for radiofrequency signals transmitted from the information handling system 200 and may extend the wireless range or improve signal of the information handling system 200 in communications with a target wireless receiver device 278 in the radiofrequency environment. Again, these EM waves may include any type of EM wave including low-band, mid-band, or high-band millimeter-wave EM waves. These may include 600-900 MHz, 1.7-6 GHz, and 24-47 GHz, among other frequencies for the radiofrequency signals in any of varied wireless communication protocols used in the radiofrequency environment.

The reconfigurable metasurface unit cell array 262 may include a plurality of reconfigurable metasurface unit cells, such as the first reconfigurable metasurface unit cell 264-1 and a second reconfigurable metasurface unit cell 264-2 is shown in FIG. 2. It is appreciated that the reconfigurable metasurface unit cell array 262 may contain any number of reconfigurable metasurface unit cells 264-1, 264-2. In one example embodiment, the reconfigurable metasurface unit cell array 262 may contain two-hundred and fifty-six reconfigurable metasurface unit cells 264-1, 264-2 arranged in rows and columns in a sixteen-by-sixteen array. It is appreciated that the reconfigurable metasurface unit cell array 262 may include any plurality of addressable reconfigurable metasurface unit cells 264-1, 264-2 in any arrangement of those unit cells 264-1, 264-2. As described herein, the reconfigurable metasurface unit cells 264-1, 264-2 within the reconfigurable metasurface unit cell array 262 may be used to, in real-time, to reconfigure its reflective properties to control the refection and steering for reflection of incoming EM waves from a transmitting source (e.g., the wireless antenna of the wireless interface adapter of the information handling system 200) to a receiver device 278 according to embodiments herein.

In an embodiment, each of the reconfigurable metasurface unit cells 264-1, 264-2 may include a plurality of resonant structures formed on a dielectric substrate. Those resonant structures may include reconfigurable resonant structures in some embodiments that may include a first metasurface reconfigurable split ring 266-1, a second metasurface reconfigurable split ring 266-2, and a third metasurface reconfigurable split ring 266-3. Further, the resonant structures may include one or more non-reconfigurable resonant structures including, for example, a non-reconfigurable metal fixed ring and non-reconfigurable metal fixed center node discussed further in embodiments herein. In an embodiment, each of the metasurface reconfigurable split rings 266-1, 266-2, 266-3 may be made of a non-volatile phase change material and a conductive bridge to complete each split ring and provide for switchable conductivity of the metasurface reconfigurable split rings 266-1, 266-2, 266-3. This phase change material may include, for example, germanium telluride (GeTe), antimony telluride (SbTe), or chalcogenide (GeSbTe) among other similar non-volatile phase change materials. The non-volatile phase change material of the metasurface reconfigurable split rings 266-1, 266-2, 266-3 may have two distinct states: an amorphous state and a crystalline state. In an embodiment, when the non-volatile phase change materials are in an amorphous state, the metasurface reconfigurable split rings 266-1, 266-2, 266-3 have a high resistance for a dielectric state. In an embodiment, when the non-volatile phase change materials are in a crystalline state, the metasurface reconfigurable split rings 266-1, 266-2, 266-3 may have a low resistance for a conductive state. In an embodiment, switching between the amorphous state and the crystalline state may be achieved via application of thermal energy from one of a plurality of refractory rings that, in an embodiment, includes a first refractory heater 268-1, a second refractory heater 268-2, and a third refractory heater 268-3 corresponding to each metasurface reconfigurable split ring 266-1, 266-2, 266-3 described herein. In an embodiment, the non-volatile phase change materials may hold a state as long as it is not actuated with another heat pulse to transition to the alternate state as either the amorphous state or the crystalline state.

In an embodiment, each of the metasurface reconfigurable split rings 266-1, 266-2, 266-3 may be selectively switched from a conductive state to an dielectric state in order to modify phase shift of reflected RF signals by way of the metasurface reconfigurable split rings 266-1, 266-2, 266-3 with the center conductive node and outer conductive ring on the incoming EM wave and yielding constructive and/or destructive interference across the plurality of reconfigurable metasurface unit cells 264-1, 264-2, thereby reflectively steering the EM wave or the RF signal in a specific direction such as in the direction of the receiver device 278. With the use of the constructive and/or destructive interference, any number of EM wave beam directions may be created that may be used to increase the feed distance or gain of the reflected EM wave beams of radiofrequency signals in order to expand radiofrequency signal range or focus the directionality of the EM wave beams for the radiofrequency signals in a radiofrequency environment. In an embodiment, the directionality and feed distance of the EM wave beams of reflected RF signals may be changed (e.g., the array of reconfigurable metasurface unit cells 264-1, 264-2 may be reconfigured) within sub-milliseconds such that data may be transmitted to various different locations within an area of the radiofrequency environment.

As described in embodiments herein, each of the reconfigurable metasurface unit cells 264-1, 264-2 may include a first refractory heater 268-1, a second refractory heater 268-2, and a third refractory heater 268-3 to each selectively apply heat pulses to the corresponding first metasurface reconfigurable split ring 266-1, the corresponding second metasurface reconfigurable split ring 266-2, and the corresponding third metasurface reconfigurable split ring 266-3, respectively. In an embodiment, each of the refractory heaters 268-1, 268-2, 268-3 may be made of tungsten (W). In an embodiment, the first metasurface reconfigurable split ring 266-1, the second metasurface reconfigurable split ring 266-2, and the third metasurface reconfigurable split ring 266-3 are formed into a first dielectric layer of dielectric substrate. Further, in an embodiment, the first refractory heater 268-1, the second refractory heater 268-2, and the third refractory heater 268-3 formed into dielectric substrate layer and under the first dielectric layer so that it is electrically insulated from the metasurface reconfigurable split rings 266-1, 266-2, and 266-3. In an embodiment, the first dielectric layer is layered onto the second dielectric substrate layer of the reconfigurable metasurface unit cell 264-1, 264-2 which each made of dielectric substrate material. The first dielectric layer, for example, silicon nitride (SiNx) or aluminum nitride (AlN). This dielectric layer may act as an electric insulator that prevents the flow of electric current from the refractory heaters 268-1, 268-2, 268-3 but is thermally conductive. Further, the metasurface reconfigurable split ring 266-1, the second metasurface reconfigurable split ring 266-2, and the third metasurface reconfigurable split ring 266-3 are disposed on the first dielectric layer thin enough such that the corresponding refractory heaters 268-1, 268-2, 268-3 may couple the incident radiofrequency signals at any of the first metasurface reconfigurable split ring 266-1, the second metasurface reconfigurable split ring 266-2, or the third metasurface reconfigurable split ring 266-3 that are in a conductive or active state. In an embodiment, the second dielectric substrate layer and lower dielectric layers may include an dielectric substrate layer made of, for example, high-temperature reusable surface insulation (HRSI), aluminum oxide (Al2O3), glass, or printed circuit board among others placed below the refractory heaters 268-1, 268-2, 268-3. These lower dielectric layers may be thermally insulative from the refractory heaters 268-1, 268-2, 268-3.

In an embodiment, each of the refractory heaters 268-1, 268-2, 268-3 are operatively coupled to a contact pad 270. The contact pads 270 may serve as a contact pad through which a metasurface PMU 272, as controlled with metasurface controller 278 may provide power to each of the refractory heaters 268-1, 268-2, 268-3 to generate heat pulses for each of the respective reconfigurable metasurface unit cells 264-1, 264-2. In an embodiment, additional layers may be formed below the refractory heaters 268-1, 268-2, 268-3. In an embodiment, these lower dielectric layers may include an dielectric substrate layer made of, for example, high-temperature reusable surface insulation (HRSI), aluminum oxide (Al2O3), glass, or printed circuit board among others placed below the refractory heaters 268-1, 268-2, 268-3. These lower dielectric layers may be thermally insulative.

In an embodiment, a metallization layer used as a radio frequency (RF) ground may be placed below the dielectric substrate layer and may be made of copper or other metal. As described herein, this metallization layer may serve as a top surface of a substrate-integrated waveguide 272-1, 272-2 formed within each of the metasurface unit cells 264-1, 264-2 of the reconfigurable metasurface unit cell array 262. FIG. 2 shows a single substrate-integrated waveguide 272-1, 272-2 for each metasurface unit cell 264-1, 264-2 and the present specification contemplates that a substrate-integrated waveguide 272-1, 272-2 may be formed into any number of metasurface unit cells 264-1, 264-2 arranged within the reconfigurable metasurface unit cell array 262. The substrate integrated waveguides 272-1, 272-2 may include a lower metallization layer forming a bottom surface and electrically coupled by a plurality of perimeter metal interconnect bars to form a shielded chamber in the substrate integrated waveguides 272-1, 272-2. Further, each of the substrate integrated waveguides 272-1, 272-2 includes one or more RF coupling elements for capturing samples of the RF signals incident on the reconfigurable metasurface unit cells according to embodiments herein.

The substrate-integrated waveguides 272-1, 272-2 may be used to interact with incoming microwave signals generated from the RF signals incident to the metasurface reconfigurable split rings 266-1, 266-2, 266-3 and coupled through the refractory heaters 268-1, 268-2, 268-3 and down the length of the individual metal interconnects that operatively couple the refractory heaters 268-1, 268-2, 268-3 to the contact pads 270 as described herein. In a specific embodiment, each of the substrate-integrated waveguides 272-1, 272-2 may include one or more RF coupling elements 291-1 and 291-2 that detect these incoming microwave signals. The substrate-integrated waveguides 272-1, 272-2 may capture samples of the radiofrequency signals via the one or more RF coupling elements 291-1, 291-2 and route the captured incident RF signals through their own coupling element metal interconnects to the contact pads 271. These signals may be passed to a centralized metasurface hardware controller 274 for use to determine how to modify a phase profile across the reconfigurable metasurface unit cell array 262 via manipulation of each metasurface reconfigurable split rings 266-1, 266-2, 266-3 via the refractory heaters 268-1, 268-2, 268-3 as described herein.

In an embodiment, the centralized metasurface hardware controller 274 may execute machine readable code instructions of a metasurface adaptive wireless beamforming system module 276. Execution of the metasurface adaptive wireless beamforming system module 276 may detect differential phase measurements across the reconfigurable metasurface unit cell array 262 from captured samples of the incident RF signal at the reconfigurable metasurface unit cell array 264 and provide signal output to be received by the metasurface microcontroller 278 to provide a heat pulse to the refractory heaters 268-1, 268-2, 268-3 to reconfigure the electromagnetic reflective properties of the reconfigurable metasurface unit cells 264-1 and 264-2 across the reconfigurable metasurface unit cell array 262 to reconfigure the reflected EM wave direction of the reflected RF signals. In an embodiment, the centralized metasurface hardware controller 274 may execute machine readable code instructions of the metasurface adaptive wireless beamforming system module 276 and generate instructions for the metasurface microcontroller 278 (e.g., field-programmable gate array (FPGA)) to direct a metasurface power management unit (PMU) 278 to send voltage for heat pulses to the refractory heaters 268-1, 268-2, 268-3 via the contact pads 170 to manipulate the phase change materials of the metasurface reconfigurable split rings 266-1, 266-2, 266-3 as described herein. These heat pulses may be provided via a metasurface battery 282 and/or metasurface A/C power adapter 284.

Thus, the substrate-integrated waveguides 272-1, 272-2 may improve the precision and accuracy of the reflected RF signal while also maintaining compactness of the reconfigurable metasurface unit cell array 262. In an embodiment, detecting the differential phase measurements by execution of the metasurface adaptive wireless beamforming system module 276 by the centralized metasurface hardware controller 274 across the surface of the reconfigurable metasurface unit cell array 262 may provide enhanced signal characterization by analyzing phase disparities and variable coupling strength between the various elements within each of the metasurface unit cells 264-1, 264-2. Even further, the use of the substrate-integrated waveguides 272-1, 272-2 in each metasurface unit cell 264-1, 264-2 allows for real-time, dynamic tuning of the reconfigurable metasurface unit cell array 262 response to incoming RF signals using adjustable voltage pulses to the refractory heaters 268-1, 268-2, 268-3 in order to dynamically switch the metasurface reconfigurable split rings 266-1, 266-2, 266-3 from a conductive state to a dielectric state or vice versa where needed and indicated by the metasurface adaptive wireless beamforming system module 276.

In an embodiment, another dielectric layer, for example made of silicon dioxide (SiO2), may be placed below the substrate-integrated waveguides 272-1, 272-2 and above the contact pads 270. Thus, in an embodiment, a number of vias are formed through the dielectric substrate layers and the metallization layers of the substrate-integrated waveguides 272-1, 272-2 to allow for the refractory heater metal interconnects and coupling element metal interconnects to pass through to the contact pads 170 or 171 respectively. Additionally, the dielectric layer placed below the refractory heaters 268-1, 268-2, 268-3 prevent contact between the bottom metallization layer of the substrate-integrated waveguide 272-1, 272-2 and the contact pads 270, 271.

In an embodiment, each of the reconfigurable metasurface unit cells 264-1, 264-2 may include other structures used to redirect transmitted EM waves and beam steer those EM waves in a desired direction. In an example embodiment, the reconfigurable metasurface unit cells 264-1, 264-2 may each include a non-reconfigurable metal fixed outer ring formed around the metasurface reconfigurable split rings 266-1, 266-2, 266-3 described herein. The non-reconfigurable metal fixed outer ring may form a passive conductive ring such that it does not require power from the metasurface PMU 272 to maintain its characteristics to contribute to the redirection of the transmitted EM waves and beam steering of those EM waves in a desired direction. In an embodiment, along with the non-reconfigurable metal fixed outer ring, each of the non-reconfigurable metal fixed split ring unit cells 264-1, 264-2 may also include a non-reconfigurable metal fixed center node formed within each of the first metasurface reconfigurable split ring 266-1 of each reconfigurable metasurface unit cell 264-1, 264-2 to also act as a passive conductive dot or pad such that it does not require power from the metasurface PMU 272 to maintain its characteristics to contribute to the redirection of the transmitted EM waves and beam steering of those EM waves in a desired direction.

As described herein, the reconfigurable metasurface unit cell array 262 may be operatively coupled to a metasurface PMU 280 and controlled via a metasurface controller 278 that may be a field programmable gate array (FPGA) circuit microchip or other hardware controller at the reconfigurable metasurface unit cell array 262. Like the PMU 228 of the information handling system 200, the metasurface PMU 280 may include control from the metasurface controller 278 to provide power to each of the refractory heaters 268-1, 268-2, 268-3 for triggered heat pulses via one or a combination of both a metasurface battery 274 and metasurface A/C power adapter 276. In an embodiment, the power needed to operate the reconfigurable metasurface unit cell array 262 may be low such that the metasurface battery 274 may be sufficient to pulse heat to the individual refractory heaters 268-1, 268-2, 268-3 in order to switch the metasurface reconfigurable split rings 266-1, 266-2, 266-3 from an amorphous state to a crystalline state or vice versa.

By switching each of the metasurface reconfigurable split rings 266-1, 266-2, 266-3 between the amorphous state and the crystalline state, the reconfigurable metasurface unit cell array 262 may be configured to redirect transmitted EM waves and beam steer those EM waves in a desired direction and may be controlled via the metasurface controller 278 or the centralized metasurface hardware controller 274. Additionally, because the heating of the phase change material of the metasurface reconfigurable split rings 266-1, 266-2, 266-3 can be achieved by applying thermal energy such as a pulse with a certain amplitude and width (on the order of nanoseconds) through the electrically insulated high-speed, refractory heaters 268-1, 268-2, 268-3, the constant application of power is not needed thereby reducing the need for a dedicated power source. Indeed, in some embodiments, these phase change materials of the metasurface reconfigurable split rings 266-1, 266-2, 266-3 hold their states as long as it is not actuated with another heat pulse to change to the other crystalline or amorphous phase.

In an embodiment, the reconfigurable metasurface unit cell array 262 may be coupled to an outer surface of the information handling system 200, for example the outer surface of a display chassis of a laptop or table style information handling system 200, such that the reconfigurable metasurface unit cell array 262 may be used to relay incoming EM waves radiofrequency signals to other locations. These other locations may be locations within a radiofrequency environment such as towards other information handling systems such as target receiver devices 278 or to a low throughput zone within the environment from a source radiofrequency signal location such as an AP 244 or base station 246. By allowing the reconfigurable metasurface unit cell array 262 placed on the information handling system 200 to act as an EM wave relay point, the radiofrequency environment that the information handling system 200 is within may be capable of transmitting those high frequency EM waves around corners and across larger distances with effective RSSI radiofrequency signals. In an embodiment, the information handling system 200 may be a laptop-type information handling system 200 and the reconfigurable metasurface unit cell array 262 may be coupled to a surface of the A-cover of the lid or top of a display panel chassis of the information handling system 200 such that, when opened, the information handling system 200 may present a flat surface for the reconfigurable metasurface unit cell array 262 to redirect incoming EM waves to those locations within the radiofrequency environment described herein.

It is appreciated, however, that the reconfigurable metasurface unit cell array 262 may act as a standalone device separate from the information handling system 200. In this example embodiment, the reconfigurable metasurface unit cell array 262 may relay or otherwise reflect incoming RF signals within an RF environment using its own power source as described in connection with the metasurface PMU 280.

In the example embodiment where the reconfigurable metasurface unit cell array 262 is operatively coupled to the information handling system 200, the user may move the information handling system 200 such that the orientation of the reconfigurable metasurface unit cell array 262 has changed. This may be a result of the user altering the orientation of the information handling system 200 by adjusting the lid portion of the information handling system 200 relative to the base portion, changing the angle of the base portion relative to a previous location, or generally moving the location of the information handling system 200 within the environment. Because the location of the reconfigurable metasurface unit cell array 262 has changed, the current orientation and angle of the beam emitted from the reconfigurable metasurface unit cell array 262 no longer is directed towards another information handling system, such as target receiver device 286, or towards the low throughput zone from a radiofrequency signal source such as AP or a base station. The reconfigurable metasurface unit cell array 262 may, in an embodiment, change the direction and magnitude of the reflected EM beam by correcting for those changes in position and location of the information handling system 200 and, accordingly, the reconfigurable metasurface unit cell array 262. In an embodiment, the hardware processor 202 of the information handling system 200 may execute machine-readable program code instructions of metasurface adaptive wireless beamforming system module 276 along with the centralized metasurface hardware controller 274 and metasurface microcontroller 278 to determine and make automatic adjustments to the reconfigurable metasurface unit cell array 262 according to embodiments herein. Execution of the machine-readable program code instructions of the metasurface adaptive wireless beamforming system module 276 causes reconfiguration of the electromagnetic reflective properties of the reconfigurable metasurface unit cell array 262 to reconfigure a reflected EM waves of radiofrequency signals towards a low throughput zone within the radiofrequency environment or towards other receiver devices 286.

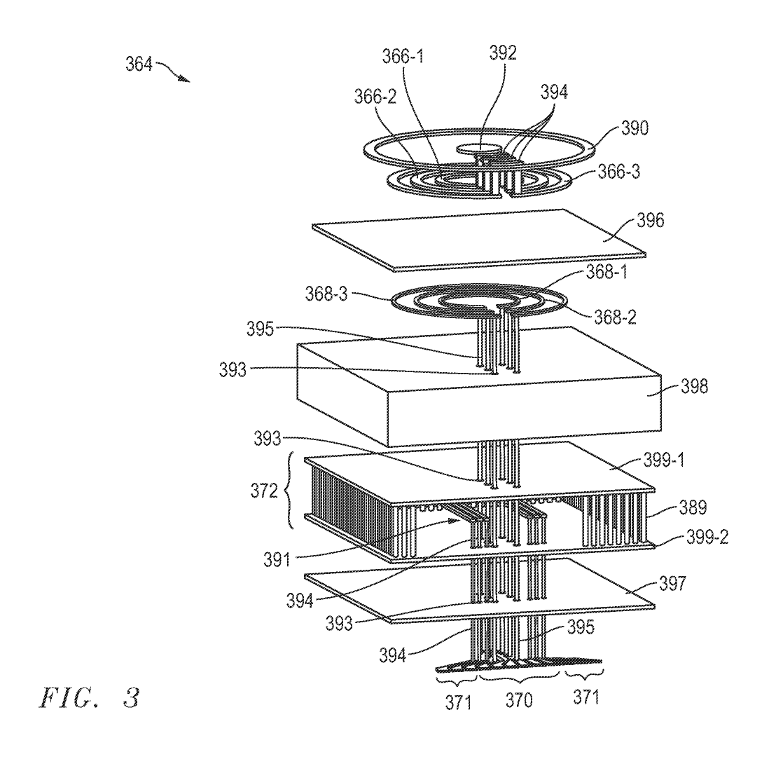

FIG. 3 is an exploded graphic diagram illustrating a perspective view of a reconfigurable metasurface unit cell 364 of a reconfigurable metasurface unit cell array that includes a substrate-integrated waveguide 372 according to an embodiment of the present disclosure. It is appreciated that each of the reconfigurable metasurface unit cells 364 of the reconfigurable metasurface unit cell array (e.g., FIG. 1, 162) may comprise their own various layers or may, in an embodiment, share one or more of the same layer or layers across a panel of the reconfigurable metasurface unit cell array. Again, the reconfigurable metasurface unit cell 364 shown in FIG. 3 may be one of a plurality of reconfigurable metasurface unit cells 364 that form the reconfigurable metasurface unit cell array and may include any number of reconfigurable metasurface unit cells 364 arranged in any manner forming a two-dimensional structure such as arranged in rows and columns of reconfigurable metasurface unit cells 364 in the reconfigurable metasurface unit cell array.

In embodiments herein, the reconfigurable metasurface unit cell 364 includes a plurality of resonant structures formed on a dielectric substrate 398 including a first dielectric layer 396 of the substrate. In an embodiment, the resonant structures include concentrically formed first metasurface reconfigurable split ring 366-1, second metasurface reconfigurable split ring 366-2, and third metasurface reconfigurable split ring 366-3 on a first dielectric layer 396 of the reconfigurable metasurface unit cell 364. Each of these metasurface reconfigurable split rings 366-1, 366-2, 366-3 are reconfigurable as to conductive or dielectric state and may include any phase change materials such as GeTe, SbTe, or GeSbTe among other similar non-volatile phase change materials and a conductive bridge 384 to complete the ring. The metasurface reconfigurable split rings 366-1, 366-2, 366-3 share the same resonant structure layer as the non-reconfigurable metal fixed ring 380, arranged as an outer ring in some embodiments or another location in other embodiments, and non-reconfigurable metal fixed center node 382 to complete a set of resonant structures. These metasurface reconfigurable split rings 366-1, 366-2, 366-3, the non-reconfigurable metal fixed ring 390, and non-reconfigurable metal fixed center node 392 act as resonant structures together in varying combinations of conductivity to control and focus the directionality of the EM wave beams reflected off of the reconfigurable metasurface unit cell array. In an embodiment, the non-reconfigurable metal fixed ring 390 and non-reconfigurable metal fixed center node 392 may be made of a metal such as gold (Au), copper (Cu), aluminum (Al), nickel (Ni) among other types of conductive metals.

In an embodiment, each of the metasurface reconfigurable split rings 366-1, 366-2, 366-3 may include a split or gap along the circumference of the metasurface reconfigurable split rings 366-1, 366-2, 366-3. As shown in FIG. 3, this gap correlates with a gap in each of the respective refractory heaters 368-1, 368-2, 368-3 formed below the first layer formed by the metasurface reconfigurable split rings 366-1, 366-2, 366-3 and a first dielectric layer 396. This enables operation of the refractory heaters 368-1, 368-2, 368-3 to pulse heat to the phase change material of the metasurface reconfigurable split rings 366-1, 366-2, 366-3 for switchable conductive or dielectric states. In order to maintain the active beam steering capabilities of each of the metasurface reconfigurable split rings 366-1, 366-2, 366-3, this gap in each metasurface reconfigurable split rings 366-1, 366-2, 366-3 may be bridged using a conductive bridge 394. The conductive bridge 394 allows for induced currents in each of the metasurface reconfigurable split rings 366-1, 366-2, 366-3 to create or adjust a phase shift in radiated fields that form the controllable reflected wave patterns across plural reconfigurable metasurface unit cells 364 in a reflected radiofrequency signal as described herein.

Below this first resonant structure layer comprised of the metasurface reconfigurable split rings 366-1, 366-2, 366-3, the non-reconfigurable metal fixed ring 380, and the non-reconfigurable metal fixed center node 382, the reconfigurable metasurface unit cell 364 includes a first dielectric layer 396. This first dielectric layer 396 may be made of SiNx of AlN. In an embodiment, this first dielectric layer 396 may include any insulating substance that does not conduct electricity but may also support electrostatic fields created during operation of the reconfigurable metasurface unit cell 364. Further, the first dielectric layer 396 may facilitate heat conduction between the refractory heaters 368-1, 368-2, 368-3 and the respective metasurface reconfigurable split rings 366-1, 366-2, 366-3.

Below the first dielectric layer 396, a second layer may be formed that comprises the first refractory heater 368-1, the second refractory heater 368-2, and the third refractory heater 368-3. The refractory heaters 368-1, 368-2, 368-3 may each, individually and selectively, heat their respective metasurface reconfigurable split ring 366-1, 366-2, 366-3 with high intensity short duration pulses of heat. Thus, when a power source is applied to the first refractory heater 368-1, the first refractory heater 368-1 heats the first metasurface reconfigurable split ring 366-1. Additionally, when the power source is applied to the second refractory heater 368-2, the second refractory heater 368-2 heats the second metasurface reconfigurable split ring 366-2. Further, when a power source is applied to the third refractory heater 368-3, the third refractory heater 368-3 heats the third metasurface reconfigurable split ring 366-3. Thus, the conductive or dielectric states of each of the metasurface reconfigurable split rings 366-1, 366-2, 366-3 may be individually switched by control via pulse heating of the individual refractory heaters 368-1, 368-2, 368-3 such that the states of the metasurface reconfigurable split rings 366-1, 366-2, 366-3 may be switched from their amorphous states to their crystalline states or vice versa.

It is appreciated that the voltage and current applied to each of the refractory heaters 368-1, 368-2, 368-3 via a first set of contact pads 370 controls the states of the metasurface reconfigurable split rings 366-1, 366-2, 366-3. For example, where the voltage applied to any of the refractory heaters 368-1, 368-2, 368-3 is high (e.g., 15-20 V) for a short period of time (e.g., up to 0.5 microseconds (µs)) with a peak current of 300 to 310 mA, the metasurface reconfigurable split rings 366-1, 366-2, 366-3 are placed in an amorphous state. This application of this voltage at this current creates a peak temperature at a metasurface reconfigurable split ring 366-1, 366-2, 366-3 of 700 to 800 ºC. An average pulse power (W) may initiate pulse heat to transition the phase change material the crystalline state at between 1 Ω to 10 Ω and to the amorphous state between 10⁵ Ω to 10⁶ Ω in order to transition from a conductive state to the dielectric state in this example. However, where the voltage applied to any of the refractory heaters 368-1, 368-2, 368-3 is relatively lower (e.g., 9-10 V) for a relatively longer period of time (e.g., 2 µs) with a peak current of 210 to 220 mA the metasurface reconfigurable split rings 366-1, 366-2, 366-3 are switched back to a crystalline state in an embodiment. This application of this voltage and current creates a peak temperature at a metasurface reconfigurable split ring 366-1, 366-2, 366-3 of 400 to 410 ºC. It is appreciated that the magnitude of the heat pulses needed to place the non-volatile phase change material of the metasurface reconfigurable split rings 366-1, 366-2, 366-3 into an amorphous state or a crystalline state depends on the type of non-volatile phase change material used. Thus, the electrical pulse from the metasurface PMU (e.g., FIG. 1, 172) at an applied voltage and current to each of the refractory heaters 368-1, 368-2, 368-3 via the first set of contact pads 370 to change the state of the non-volatile phase change material of each metasurface reconfigurable split ring 366-1, 366-2, 366-3 may depend on the type of non-volatile phase change material used. The present specification contemplates that any of a plurality of non-volatile phase change materials may be used necessitating changes in these applied voltages and currents.

Other layers and substrates may also be included in the stack within the reconfigurable metasurface unit cell 364. In an example embodiment, the reconfigurable metasurface unit cell 364 may further include a dielectric substrate 398 layer formed below a layer that comprises the refractory heaters 368-1, 368-2, 368-3. In some embodiments, the refractory heaters 368-1, 368-2, 368-3 may be formed into the dielectric substrate layer 398 and covered or layered over with the first dielectric layer 396 of the same material. This dielectric substrate layer 398 may be made of a HRSI, Al₂O₃, glass, or PCB among other dielectric materials. In an embodiment, the first dielectric layer 396 and dielectric substrate layer 398 may electrically isolate the refractory heaters 368-1, 368-2, 368-3 from the remaining portions of the reconfigurable metasurface unit cell 364. The dielectric substrate layer 398 includes a plurality of refractory heater metal interconnects 395 between the refractory heaters 368-1, 368-2, 368-3 and a corresponding addressable first set of contact pads 370.

In an embodiment, a first metallization layer 399-1 may be formed below the dielectric substrate layer 398. This metallization layer 399-1 may be made of Au, Cu, Al, or Ni among other types of metals. In an embodiment, this metallization layer 399-1 may serve as an RF grounding source for the reconfigurable metasurface unit cell 364. In the embodiments herein, the first metallization layer 399-1 may also serve as a top portion of the substrate-integrated waveguide 372 for radiofrequency isolation within the substrate-integrated waveguide 372.

In an embodiment, the substrate-integrated waveguide 372 may be any type of RF waveguide that is used to hold, trap, carry, or otherwise enable capture of those received RF signals (generally at microwave frequencies) incident to the reconfigurable metasurface unit cell 364 from the radiofrequency environment. In an embodiment, the substrate-integrated waveguide 372 may be in the form of a “jail” that includes a first metallization layer 399-1 serving as a top surface and a second metallization layer 399-2 serving as bottom surface, respectively, of a chamber for the substrate-integrated waveguide 372. A series of conductive perimeter interconnect bars 389 may be formed and electrically coupled between the top metallization layer 399-1 and bottom metallization layer 399-2. The perimeter interconnect bars 389 may be spaced apart closely enough, such as less than particular wavelengths, in order to trap a specific wavelength of detected incident radiofrequency signals within the chamber of the substrate-integrated waveguide 372, but also keep those wavelengths and longer wavelength radiofrequency signals or noise out of the internal chamber of the substrate-integrated waveguide 372. It is appreciated that some of the perimeter interconnect bars 389 shown in FIG. 3 have been removed to show an interior chamber of the substrate-integrated waveguide 372 and, in the embodiments described herein, the perimeter interconnect bars 389 would be formed completely around the perimeter between the top metallization layer 399-1 the bottom metallization layer 399-2 to form an isolated internal chamber of the substrate-integrated waveguide 372 as shown. In an embodiment, the substrate-integrated waveguide 372 may be used to probe or otherwise sample a small portion of the incident radiofrequency signal received at the resonant structures including the metasurface reconfigurable split rings 366-1, 366-2, 366-3. The incident radiofrequency signals received at the metasurface reconfigurable split rings 366-1, 366-2, 366-3 or outer conductive ring 390 may couple to the closely located refractory heaters 368-1, 368-2, or 368-3 and are transmitted down and through the refractory heater metal interconnects 395 that are formed through the isolated chamber withing the substrate-integrated waveguide 372. The refractory heater metal interconnects 395 that couple the refractory heaters 368-1, 368-2, 368-3 through the dielectric substrate layer 398, substrate-integrated waveguide 372, and a second, bottom dielectric layer 397 to the first set of contact pads 370.

During operation, the metasurface reconfigurable split rings 366-1, 366-2, 366-3 may receive the incoming RF signal and couple the same to the metal refractory heaters 368-1, 368-2, 368-3 that are closely disposed under the first dielectric layer 396. These coupled incident radiofrequency signals may be transmitted signal down into the reconfigurable metasurface unit cell 364 via the refractory heater metal interconnects 395 passing through the substrate-integrated waveguide 372. At this point, the substrate-integrated waveguide 372 includes one or more RF coupling elements 391 of conductive lines formed around, but not in electrical contact with, the refractory heater metal interconnects 395 at varying distances in the shielded chamber of the substrate-integrated waveguide 372. These RF coupling elements 391 when active, may couple and capture at least a portion of the incident RF signal as an RF signal readout at the second set of contact pads 371. This captured portion of the incident RF signal provided as a captured RF signal readout from the reconfigurable metasurface unit cell 364 may be transmitted to a centralized metasurface hardware controller in order to obtain specific information or characteristics related to those RF signals incident to the reconfigurable metasurface unit cell array. These characteristics may include phase-shift profiles, angle-of-arrival (AoA) of the signal, the field of the RF signal, the phase disparities in the signal, interference patterns within the signal, among other signal characteristics. One or more RF coupling elements 391 may be activated and used to couple and capture the incident RF signal depending on the strength of the captured incident RF signal needed to obtain the characteristics for the centralized metasurface hardware controller. These one or more active RF coupling elements 391 are operatively coupled via coupling element metal interconnects 394 to transmit the captured incident RF signal down through the second set of contact pads 371 and to the central metasurface hardware controller in order to determine these signal characteristics.

In the embodiment shown in FIG. 3, the RF coupling elements 391 in the shielded chamber of the substrate-integrated waveguide 372 may include three separate RF coupling elements 391 that are also electrically coupled to the respective second set of contact pads 371 via their own dedicated coupling element interconnects 394. Each of the RF coupling elements 391 may have different thicknesses such that each individual RF coupling element 391 alone or together as a plurality of individual RF coupling elements 391 may be capable of sampling varying amounts or strength of the signal received within the substrate-integrated waveguide 372. The second set of contact pads 371 may be addressed with voltage to activate one or more of the RF coupling elements 391 depending on the strength of the captured incident RF signal needed. It is appreciated that this process may be conducted for each reconfigurable metasurface unit cell 364 at each substrate-integrated waveguide 372 therein in order to obtain the signal characteristics of the signal at each individual reconfigurable metasurface unit cell 364. This allows the signals received at each of the RF coupling elements 391 at each of the reconfigurable metasurface unit cells 364 (e.g., neighboring reconfigurable metasurface unit cells 364) to be transmitted to the centralized metasurface hardware controller (not shown) in order to obtain additional signal characteristics that can be differentiated among each other across the reconfigurable metasurface unit cell array. In an example embodiment, this allows for additional information to be received and evaluated by the central metasurface hardware controller via execution of the metasurface adaptive wireless beamforming system module (e.g., FIG. 1, 176).

In an embodiment, a second dielectric layer 397 may be placed below the bottom metallization layer 399-2 of the substrate-integrated waveguide 372. This second dielectric layer 397 may be made of silicon dioxide (SiO₂). Similar to the first dielectric layer 396, the second dielectric layer 397 may also support electrostatic fields created during the operation of the reconfigurable metasurface unit cell 364. In other embodiments, the second dielectric layer 397 may be thicker than the first dielectric layer 396 to support isolation. In various embodiments, the dielectric substrate layer 398, the first dielectric layer 396, and the second dielectric layer 397 may be formed to encapsulate the refractory heaters 368-1, 368-2, 368-3 and the substrate-integrated waveguide 372 at levels or layers in the reconfigurable metasurface unit cell 364. Further, resonant structures such as the metasurface reconfigurable split rings 366-1, 366-2, 366-3, the non-reconfigurable metal fixed ring 390, and non-reconfigurable metal fixed center node 392 may be disposed on the first dielectric layer 396 of the dielectric substrate layer 398 of each reconfigurable metasurface unit cell 364.

Below the second dielectric layer 397, the first set of contact pads 370 are used to electrically address the refractory heaters 368-1, 368-2, 368-3, via the refractory heater metal interconnects 395, with a metasurface PMU (e.g., FIG. 1172) as controlled with the central metasurface hardware controller in an embodiment. Below the second dielectric layer 397, the second set of contact pads 371 are used to activate and detect captured incident radiofrequency signals with one or more of the RF coupling elements 391 via the coupling element metal interconnects 396 and transmit the captured incident radiofrequency signal sample to the central metasurface hardware controller. The first and second set of contact pads 370 and 371 may be made of any conductive metal such as Au, Cu, Al, or Ni among other types of metals. In relation to the refractory heaters 368-1, 368-2, 368-3, the first set of contact pads 370 may receive those electrical pulses from the metasurface PMU in order to pulse heat, individually, each of the refractory heaters 368-1, 368-2, 368-3. As described, in order to operatively couple each of the refractory heaters 368-1, 368-2, 368-3 to a respective contact pad of the first set of contact pads 370, a plurality of refractory heater metal interconnects 395 are formed. In the example embodiment shown in FIG. 3, the refractory heater metal interconnects 395 couple a contact pad in the first of contact pads 370 to each terminal end of each of the refractory heaters 368-1, 368-2, 368-3 through the dielectric substrate layers 396, 397 and 398 as well as the substrate-integrated waveguide 372. In order to do so, one or more vias 393 are formed through, at least, the second dielectric layer 397, the metallization layers 399-1 and 399-2 of the substrate-integrated waveguide 372, and the dielectric substrate layer 398 so that the refractory heater metal interconnects 395 may pass from each of the respective first set of contact pads 370 to their respective refractory heaters 368-1, 368-2, 368-3.

Similarly, in relation to the RF coupling elements 391, a second set of contact pads 371 may be used to activate specific RF coupling elements 391 and transmit the captured incident RF signals coupled via the active RF coupling elements 391 to the central metasurface hardware controller via other coupling element metal interconnects 396. Again, similar vias 393 may be formed through the second dielectric layer 397 and the bottom metallization layer 399-2 of the substrate-integrated waveguide 372 so that these other coupling element metal interconnects 395 may pass through those layers of the reconfigurable metasurface unit cell 364 from the second set of contact pads 371 and be electrically coupled to the RF coupling elements 391 in the shielded substrate-integrated waveguide 372.

FIG. 3 shows a single reconfigurable metasurface unit cell 364 among a plurality of reconfigurable metasurface unit cells 364 that may form the reconfigurable metasurface unit cell array. It is appreciated that the reconfigurable metasurface unit cell array may comprise any number of individually activatable reconfigurable metasurface unit cells 364. In one example embodiment, the reconfigurable metasurface unit cell array may place the reconfigurable metasurface unit cells 364 in a row and column orientation thereby forming, for example, a sixteen-by-sixteen reconfigurable metasurface unit cell array.

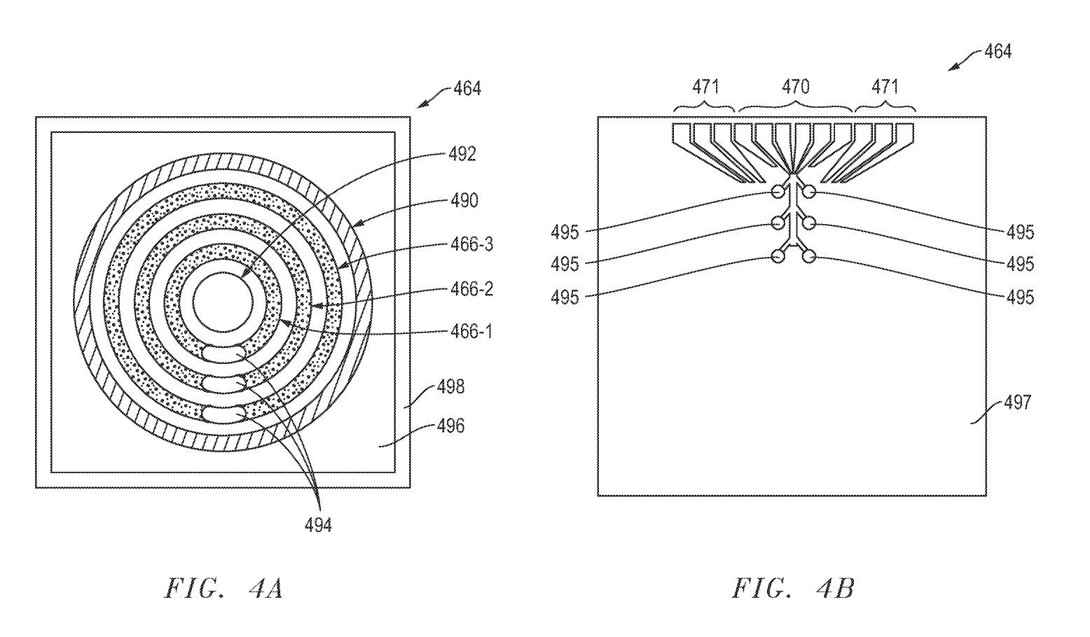

FIG. 4A is a top view graphic diagram showing a plurality of metasurface resonant structures including the reconfigurable split rings 466-1, 166-2, 466-3 of a reconfigurable metasurface unit cell 464 according to an embodiment of the present disclosure. Additionally, FIG. 4B is a bottom view diagram showing a first set of contact pads 470 and a second set of contact pads 471 of the reconfigurable metasurface unit cell 464 according to an embodiment of the present disclosure. FIG. 4A shows the first dielectric layer 496 and dielectric substrate layer 498 showing that these two layers reside below the first resonant structure layer that comprises the first metasurface reconfigurable split ring 466-1, the second metasurface reconfigurable split ring 466-2, the third metasurface reconfigurable split ring 466-3, the non-reconfigurable metal fixed ring 490, and the non-reconfigurable metal fixed center node 492 of a reconfigurable metasurface unit cell 464. Although the non-reconfigurable metal fixed ring 490 is shown as an outer ring of the reconfigurable metasurface unit cell 464, it is contemplated that the reconfigurable metasurface unit cell 464 may have the non-reconfigurable metal fixed ring 490 as any ring in the sequence of concentric plurality of metasurface reconfigurable rings 466-1, 466-2, 466-3 in various embodiments. Further, although a circular shape is shown for the plurality of metasurface reconfigurable rings 466-1, 466-2, 466-3 and the non-reconfigurable metal fixed ring 490, other concentric shapes are contemplated and may be implemented according to embodiments of the present disclosure including oval shapes, any geometric shapes, irregular shapes, or a mix of concentric shapes in various embodiments herein.

As described herein, each of these metasurface reconfigurable split rings 466-1, 466-2, 466-3 may include any phase change materials such as GeTe, SbTe, or GeSbTe among other similar non-volatile phase change materials. The metasurface reconfigurable split rings 466-1, 466-2, 466-3 share the same resonant structure layer as the non-reconfigurable metal fixed ring 490 and non-reconfigurable metal fixed center node 492 disposed on the first dielectric layer 496. These resonant structures including the plurality of metasurface reconfigurable rings 466-1, 466-2, 466-3, the non-reconfigurable metal fixed ring 490, and non-reconfigurable metal fixed node 492 act together to focus to impart a phase-shift adjustment to reflection of incident radiofrequency signals. This may be used across a plurality of reconfigurable metasurface unit cells 464 to beamsteer the directionality of the EM wave beams of radiofrequency signals reflected off of the reconfigurable metasurface unit cell array. In an embodiment, the non-reconfigurable metal fixed ring 490 and non-reconfigurable metal fixed center node 492 may be made of a metal such as gold (Au), copper (Cu), aluminum (Al), nickel (Ni) among other types of conductive metals.

In an embodiment, each of the metasurface reconfigurable split rings 466-1, 466-2, 466-3 may include a split or gap along the circumference of the metasurface reconfigurable split rings 466-1, 466-2, 466-3. As shown in FIG. 3, for example, this gap correlates with a gap in each of the respective refractory heaters (e.g., FIG. 3, 368-1, 368-2, 368-3) formed below the first layer formed by the metasurface reconfigurable split rings 466-1, 466-2, 466-3 and a first dielectric layer 496. In order to complete the ring or other shaped structure each of the metasurface reconfigurable split rings 466-1, 466-2, 466-3, this gap in each metasurface reconfigurable split rings 466-1, 466-2, 466-3 may be bridged using its own conductive bridge 494. The conductive bridges 494 allow for induced currents in each of the metasurface reconfigurable split rings 466-1, 466-2, 466-3 to create radiated fields that form the phase-shift in reflected wave patterns and control of directionality of those radiofrequency signals as phase shifted across the plural reconfigurable metasurface unit cells as described herein.

It is appreciated that each of the terminal ends of each refractory heater structure corresponding to each of the metasurface reconfigurable rings 466-1, 466-2, 466-3 may be operatively coupled to a first set of contact pads 470 via one or more refractory heater metal interconnects 495 as shown in FIG. 4B. The refractory heater metal interconnects 495 terminate at the first set of contact pads 470 may be placed directly below each terminal end of each refractory heater structure corresponding to each of metasurface reconfigurable ring 466-1, 466-2, 466-3 such that the vias may be formed through the various layers of the reconfigurable metasurface unit cell 464 with the refractory heater metal interconnects 495 operatively coupling the refractory heaters to a respective set of contact pads in the first set of contact pads 470. FIG. 4B also shows an example arrangement of each of the first set of contact pads 470 and refractory heater metal interconnects 495 such that a metasurface PMU may provide the necessary electrical pulses to each refractory heater structure corresponding to each of the metasurface reconfigurable rings 466-1, 466-2, 466-3 as described herein. Similarly, the second set of contact pads 471 may operatively couple coupling element metal interconnects associated with the RF coupling elements (e.g., FIG. 3, 391) to the second set of contact pads 471 for activation of RF coupling elements to capture and transmit the sampled incident RF signal coupled from the refractory heater metal interconnects 495 within the substrate-integrated waveguide (e.g., FIG. 3, 372).

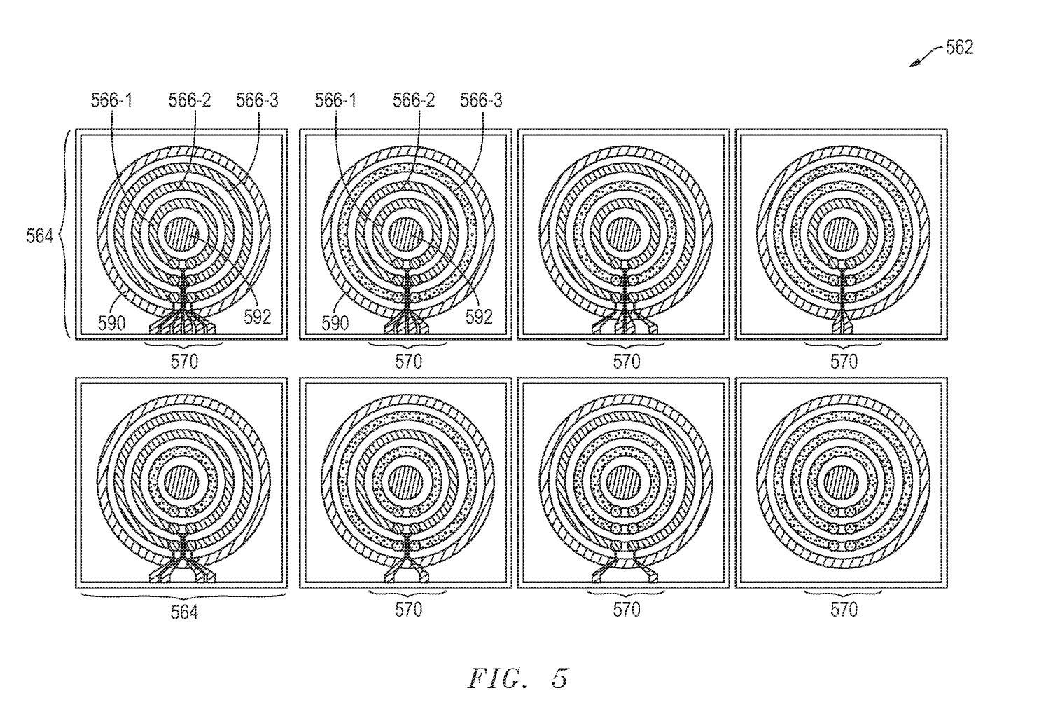

FIG. 5 is graphic diagram of a top view of a plurality of reconfigurable metasurface unit cells 564 of a reconfigurable metasurface unit cell array depicting various activation states of the plurality of unit cells according to an embodiment of the present disclosure. It is appreciated that although FIG. 5 shows a reconfigurable metasurface unit cell array 562 having a four by two unit cell 564 arrangement, this may represent only a portion of a reconfigurable metasurface unit cell array 562 in an embodiment. The present specification contemplates that the reconfigurable metasurface unit cell array 562 may include more or fewer reconfigurable metasurface unit cells 564 than those shown in FIG. 5. In an embodiment, the reconfigurable metasurface unit cell array 562 may be an array of sixteen unit cells 564 by sixteen reconfigurable metasurface unit cells 564. It is also appreciated that although for purposes of description, FIG. 5 is described with respect to the various elements of the reconfigurable metasurface unit cells 564 in the top-left two unit cells 564, the other reconfigurable metasurface unit cells 564 depicted in FIG. 5 include similar elements and operation as described in FIG. 5.

Again, each reconfigurable metasurface unit cell 564 may include a first metasurface reconfigurable split ring 566-1, a second metasurface reconfigurable split ring 566-2, and a third metasurface reconfigurable split ring 566-3. Each of these metasurface reconfigurable split rings 566-1, 566-2, 566-3 may include any phase change materials such as GeTe, SbTe, or GeSbTe among other similar non-volatile phase change materials. The metasurface reconfigurable split rings 566-1, 566-2, 566-3 share the same resonant structure layer as the non-reconfigurable metal fixed ring 590 and non-reconfigurable metal fixed center node 592 and act together to adjust phase-shift to incident RF signals and across the plurality of reconfigurable metasurface unit cells 564 focus the directionality of the EM wave beams reflected off of the reconfigurable metasurface unit cell array according to embodiments herein. In an embodiment, the non-reconfigurable metal fixed ring 590 and non-reconfigurable metal fixed center node 582 may be made of a metal such as Au, Cu, Al, and Ni among other types of conductive metals.

As shown in FIG. 5, the top left unit cell 564 shows that all three of the metasurface reconfigurable rings 566-1, 566-2, 566-3 have been placed in an amorphous state. This amorphous or dielectric state is indicated by the hash fill of these elements indicating, in this example embodiment, that these metasurface reconfigurable rings 566-1, 566-2, 566-3 have been placed in the amorphous state and are non-conductive. Again, these states in each of the metasurface reconfigurable rings 566-1, 566-2, 566-3 are achieved and individually controlled via pulse heating of the individual refractory heaters (not shown) such that the states of the metasurface reconfigurable rings 566-1, 566-2, 566-3 may be switched from their amorphous states to their crystalline states or vice versa.

FIG. 5 shows that a neighboring reconfigurable metasurface unit cell 564 to the immediate right of the left-most upper unit cell 564 has two of the metasurface reconfigurable rings 566-1 and 566-2 that have been placed in the amorphous state while another metasurface reconfigurable ring 566-3 has been placed in the crystalline state. In this example, the first metasurface reconfigurable split ring 566-1 and second metasurface reconfigurable split ring 566-2 have been placed in the amorphous state indicated by the hash fill and which is non-conductive while the third metasurface reconfigurable split ring 566-3 has been placed in the crystalline state which is conductive as indicated by the dotted fill for this element. Again, it is appreciated that the pulse of voltage and current applied to each of the refractory heaters controls the states of the metasurface reconfigurable rings 566-1, 566-2, 566-3. For example, where the voltage pulse applied to any of the refractory heaters is high (e.g., 15-20 V) for a short period of time (e.g., up to 0.5 µs) with a peak current of 300 to 310 mA, the metasurface reconfigurable rings 566-1, 566-2, 566-3 may be transitioned from the crystalline state to an amorphous state as shown in the first metasurface reconfigurable split ring 566-1 and second metasurface reconfigurable split ring 566-2. The application of this voltage pulse at this current creates a peak temperature at the first metasurface reconfigurable split ring 566-1 and second metasurface reconfigurable split ring 566-2 of 700 to 800 ºC in order to transition from the crystalline state to this amorphous state in this example. Such a heat pulse may change the first metasurface reconfigurable split ring 566-1 and the second metasurface reconfigurable split ring 566-2 as described.

In another embodiment, however, where the voltage pulse applied to any of the refractory heaters is relatively lower (e.g., 9-10 V) for a relatively longer period of time (e.g., 2 µs) with a peak current of 210 to 220 mA the metasurface reconfigurable split rings 566-1, 566-2, 566-3 may be transitioned from the amorphous state to a crystalline state such as that shown in the third metasurface reconfigurable split ring 566-3. This application of this voltage at this current creates a peak temperature at the third metasurface reconfigurable split ring 566-3 of 400 to 410 ºC in order to transition from the amorphous state to this crystalline state in a second example as may be shown in the difference of activated metasurface reconfigurable rings 566-1, 566-2 between the two top row neighboring reconfigurable metasurface unit cells 564. It is appreciated that in order to place the non-volatile phase change material of the metasurface reconfigurable rings 566-1, 566-2, 566-3 into an amorphous state or a crystalline state depends on the type of non-volatile phase change material used. Thus, the electrical pulse from the metasurface PMU (e.g., FIG. 1, 180) at an applied voltage and current to each of the refractory heaters to change the state of the non-volatile phase change material of each metasurface reconfigurable rings 566-1, 566-2, 566-3 may depend on the type of non-volatile phase change material used and the present specification contemplates that other non-volatile phase change materials may be used necessitating changes in these applied voltages and currents.

Because each of the individual reconfigurable metasurface unit cells 564 shown in FIG. 5 may be individually tuned such that each of the individual metasurface reconfigurable rings 566-1, 566-2, 566-3 can be changed from an amorphous state to a crystalline state or vice versa, the phase shift for each reconfigurable metasurface unit cell 564 may be adjusted accordingly with these individual metasurface reconfigurable split rings 566-1, 566-2, 566-3 in relation to the non-reconfigurable metal fixed ring 590 and non-reconfigurable metal fixed center node 582 as resonating structures. The EM wave reflection properties of RF signals reflected by the reconfigurable metasurface unit cell array 562 may be changed in each reconfigurable metasurface unit cell 564 and across the reconfigurable metasurface unit cell array to direct or focus receipt or reflection of radiofrequency signals between a source wireless information handling system and a target wireless information handling system. In an embodiment, the amorphous state or crystalline state of some metasurface reconfigurable rings 566-1, 566-2, 566-3 may be changed such that each individual unit cell 564 may generate phase-shifting in reflected RF signals to engage in constructive or destructive interference across plural reconfigurable metasurface unit cells 564. This constructive or destructive interference may contribute, as whole, to the beam forming capabilities of the reconfigurable metasurface unit cell array 562 thereby allowing for an increase or decrease in feed distance of the reflected EM waves, and or higher or lower power distribution plane distance across the surface of the reconfigurable metasurface unit cell array 562 in order to adjust directionality lobes of EM wave reflection and distribution of radiofrequency signals between source and target wireless devices in a radiofrequency environment.

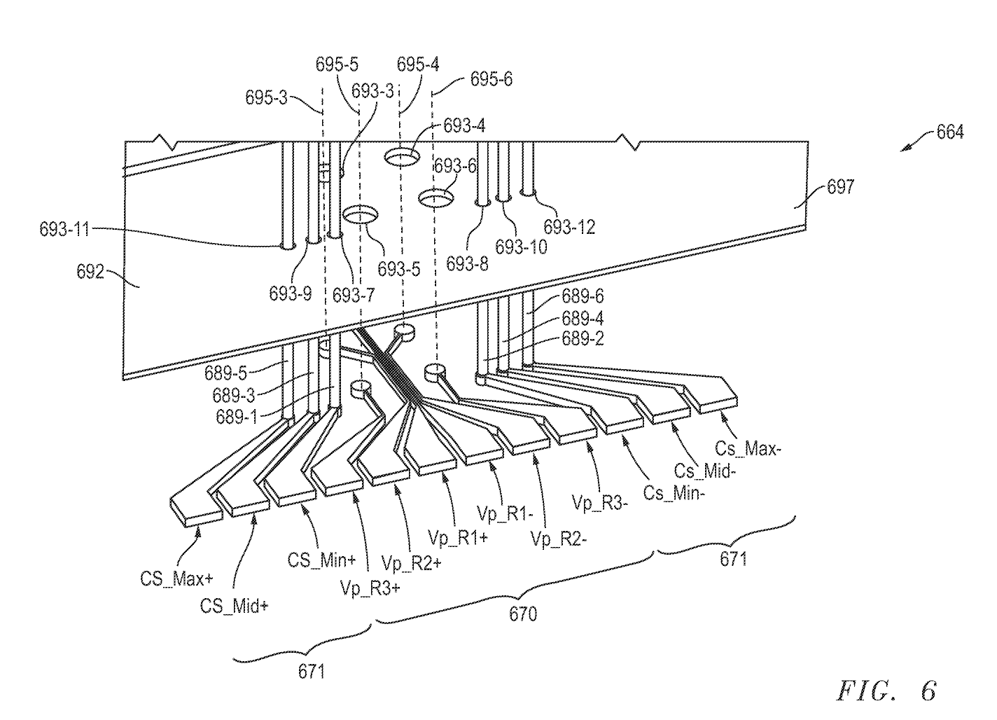

FIG. 6 is an exploded graphic diagram of a first set of contact pads 670 and a second set of contact pads 671 of a reconfigurable metasurface unit cell 664 according to another embodiment of the present disclosure. As described herein, at least a first subset of the contact pads 670 may be used in connection with the refractory heaters (e.g., FIG. 3, 368-1, 368-2, 368-3) while a second set of contact pads 671 is used in connection with the RF coupling elements (e.g., FIG. 3, 391). In an embodiment, each pair of the first set of contact pads 670 may be assigned to specific refractory heaters and each pair of the second set of contact pads 671 may be assigned to specific RF coupling elements in order to interface, respectively, with the metasurface microcontroller (e.g., FIG. 1, 178) and/or central metasurface hardware controller (e.g., FIG. 1, 174).

For example, a first set of contact pads 670 may form pairs for specifically interfacing with corresponding refractory heaters. As shown in FIG. 6, a first contact pad “Vp_R1+” may be operatively coupled to a first terminal end of a first refractory heater using a first refractory heater metal interconnect (not shown) while a second contact pad “Vp_R1-” may be operatively coupled to a second terminal end of the first refractory heater using a second refractory heater metal interconnect (not shown). At the first contact pad “Vp_R1+” and the second contact pad “Vp_R1-,” the central metasurface hardware controller directs the metasurface microcontroller to provide a voltage across the first contact pad “Vp_R1+” and second contact pad “Vp_R1-” in order to provide those heat pulses as described herein to activate the first refractory heater.

In an embodiment, a third contact pad “Vp_R2+” may be operatively coupled to a first terminal end of a second refractory heater using a third refractory heater metal interconnect 695-3 while a fourth contact pad “Vp_R2-” may be operatively coupled to a second terminal end of the second refractory heater using a fourth refractory heater metal interconnect 695-4. At the third contact pad “Vp_R2+” and the third contact pad “Vp_R2+,” the central metasurface hardware controller directs the metasurface microcontroller to provide a voltage across the third contact pad “Vp_R2+” and fourth contact pad “Vp_R2-” in order to provide those heat pulses as described herein to activate the second refractory heater.

In an embodiment, a fifth contact pad “Vp_R3+” may be operatively coupled to a first terminal end of a third refractory heater using a fifth refractory heater metal interconnect 695-5 while a sixth contact pad “Vp_R3-” may be operatively coupled to a second terminal end of the third refractory heater using a sixth refractory heater metal interconnect 695-6. At the fifth contact pad “Vp_R3+” and the sixth contact pad “Vp_R3-,” the central metasurface hardware controller directs the metasurface microcontroller to provide a voltage across the fifth contact pad “Vp_R3+” and sixth contact pad “Vp_R3-” in order to provide those heat pulses as described herein to activate the third refractory heater.

A second set of contact pads 671 may be used by the central metasurface hardware controller and metasurface microcontroller to activate or interface with the RF coupling elements described herein. For example, a seventh contact pad “Cs_Min+” may be operatively coupled to a first terminal end of a first RF coupling element using a first coupling element metal interconnect 689-1 while an eighth contact pad “Cc_Min-” may be operatively coupled to a second terminal end of the first RF coupling element using a second coupling element metal interconnect 689-2. At the seventh contact pad “Cs_Min+” and the eight contact pad “Cs_Min-,” the central metasurface hardware controller receives input of a signal report for the captured incident RF signal at a first coupling strength of the first RF coupling element used to capture the incident RF signals to detect those characteristics related to those RF signals incident to the reconfigurable metasurface unit cell array.

Additionally, a ninth contact pad “Cs_Mid+” may be operatively coupled to a first terminal end of a second RF coupling element using a third coupling element metal interconnect 689-3 while a tenth contact pad “Cs_Mid-” may be operatively coupled to a second terminal end of the second RF coupling element using a fourth coupling element metal interconnect 689-4. At the ninth contact pad “Cs_Mid+” and the tenth contact pad “Cs_Mid-,” the central metasurface hardware controller receives a signal report for the captured incident RF signal at a second coupling strength of the second RF coupling element used to capture the incident RF signals to detect those characteristics related to those RF signals incident to the reconfigurable metasurface unit cell array.

Additionally, an eleventh contact pad “Cs_Max+” may be operatively coupled to a first terminal end of a third RF coupling element using a fifth coupling element metal interconnect rod 689-5 while a twelfth contact pad “Cs_Max-” may be operatively coupled to a second terminal end of the third RF coupling element using a sixth coupling element metal interconnect 689-6. At the eleventh contact pad “Cs_Max+” and the twelfth contact pad “Cs_Max-” the central metasurface hardware controller receives input a signal report for the captured incident RF signal at a third coupling strength of the third RF coupling element used to capture the incident RF signals to detect those characteristics related to those RF signals incident to the reconfigurable metasurface unit cell array.

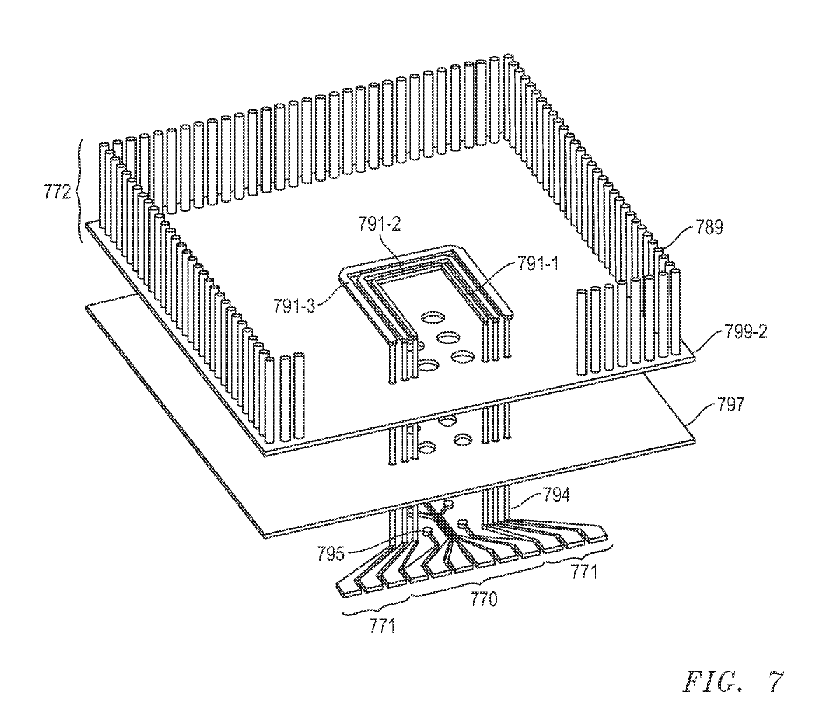

FIG. 7 is an exploded graphic diagram of a substrate-integrated waveguide 772 of a reconfigurable metasurface unit cell according to an embodiment of the present disclosure. In an embodiment, the substrate-integrated waveguide 772 may be any type of RF waveguide that is used to hold, trap, carry, or otherwise couple those received RF signals (generally at microwave frequencies) incident to a surface of the reconfigurable metasurface unit cell. In an embodiment, the substrate-integrated waveguide 772 may include a top metallization layer serving as a top surface (cutaway and not shown) and a bottom metallization layer 799-2 serving as a bottom surface, respectively, of the substrate-integrated waveguide 772. A series of perimeter interconnect bars 789 may be placed and electrically coupled between the top metallization layer and the bottom metallization layer 799-2. The perimeter interconnect bars 789 may be spaced apart, but close enough, to shield specific at or above wavelengths of radiofrequency signals or noise and trap the coupling signals for the captured incident RF signals from the refractory heater metal interconnects 795 formed through the chamber of the substrate-integrated waveguide 772. It is appreciated that some of the perimeter interconnect bars 789 shown in FIG. 7 have been removed to show an interior chamber of the substrate-integrated waveguide 772 and to show the first RF coupling element 791-1, the second RF coupling element 791-2, and the third RF coupling element 791-3. In several embodiments, the perimeter interconnect bars 789 would be formed completely around the perimeter of the second metallization layer 799-2 of the substrate-integrated waveguide 772. In an embodiment, the substrate-integrated waveguide 772 may be used to probe or otherwise sample a small portion of the incident RF signal received at the metasurface reconfigurable split rings (not shown) or other resonant structures of the reconfigurable metasurface unit cell via coupling to the one or more RF coupling elements 791-1, 791-2, or 791-3 formed around the refractory heater metal interconnects 795 formed through the substrate integrated waveguide 772. Selection of the one or more RF coupling elements 791-1, 791-2, or 791-3 to couple and capture the incident RF signal may depend on which of the metasurface reconfigurable split rings (not shown) are active as resonant structures for the reconfigurable metasurface unit cell. The incident RF signal coupled between a metasurface reconfigurable split ring in a conductive state to the corresponding refractory heater and is transmitted down and through the refractory heater to the refractory heater metal interconnect 795 within the substrate-integrated waveguide 772. The one or more active RF coupling elements 791-1, 791-2, or 791-3 formed around the refractory metal interconnects 795 may then couple to capture samples of the captured RF signal incident to the reconfigurable metasurface unit cell. These refractory heater metal interconnects 795 couple the refractory heaters to the first set of contact pads 770.

During operation, any active metasurface reconfigurable split rings may receive the incoming RF signal and this may be coupled to the corresponding metal refractory heaters which transmit that signal to the metal interconnect rods passing through the substrate-integrated waveguide 772. At this point, any active RF coupling elements 791-1, 791-2, or 791-3 may be used to couple to an active metasurface reconfigurable split ring via corresponding refractory heater metal interconnects 795 in the substrate-integrated waveguide 772 to trap or capture, at least, a portion of the incident RF signal and report that captured signal to a centralized metasurface hardware controller. The number of active RF coupling elements 791-1, 791-2, or 791-3 used to report that captured incident RF signal via coupling element metal interconnects 395 may depend on active number of metasurface reconfigurable split rings in a conductive state. Those active RF coupling elements 791-1, 791-2, or 791-3 may be triggered via the one or more contact pads of the second set of contact pads 791 depending on the strength of the captured incident RF signal and the strength of that signal needed to determine characteristics of the incident RF signals. These second set of contact pads 791 then report the captured incident RF signal to the centralized metasurface hardware controller in order to determine and obtain specific information or characteristics related to those RF signals incident to the reconfigurable metasurface unit cell array. These characteristics may include AoA of the signal, the field of the RF signal, the phase disparities in the signal, interference patterns within the signal, among other signal characteristics. As the captured incident RF signal sample is coupled by one or more of the first RF coupling element 791-1, the second RF coupling element 791-2, and the third RF coupling element 791-3 corresponding to the conductive metasurface reconfigurable split rings, it may be used in real time to capture and transmit the captured incident RF signal sample down through the second set of contact pads 771 by the coupling element metal interconnects 794 and to the central metasurface hardware controller in order to determine these signal characteristics.

In an embodiment, the RF coupling elements 791-1, 791-2, 791-3 are electrically coupled to respective contact pad pairs of the second set of contact pads 771 via their own dedicated coupling element metal interconnects 794. Each of the RF coupling elements 791-1, 791-2, 791-3 may be formed to have different thicknesses such that each individual RF coupling element 791-1, 791-2, 791-3 alone or together as a plurality of individual RF coupling elements 391 may be capable of sampling varying amounts of the captured incident RF signal received within the substrate-integrated waveguide 772. It is appreciated that this process may be conducted for each reconfigurable metasurface unit cell at each substrate-integrated waveguide 772 therein in order to obtain the signal characteristics of the incident RF signal at each individual reconfigurable metasurface unit cell. This allows the incident RF signals received at each of the RF coupling elements in the substrate-integrated waveguides at each of a plurality of the reconfigurable metasurface unit cells (e.g., neighboring reconfigurable metasurface unit cells) to be transmitted to the centralized metasurface hardware controller in order to obtain additional signal characteristics that can be differentiated among each other such as with respect to phase-differential profiles or AoA. This allows for additional information to be received and evaluated by the central metasurface hardware controller via execution of the metasurface adaptive wireless beamforming system module (e.g., FIG. 1, 176).

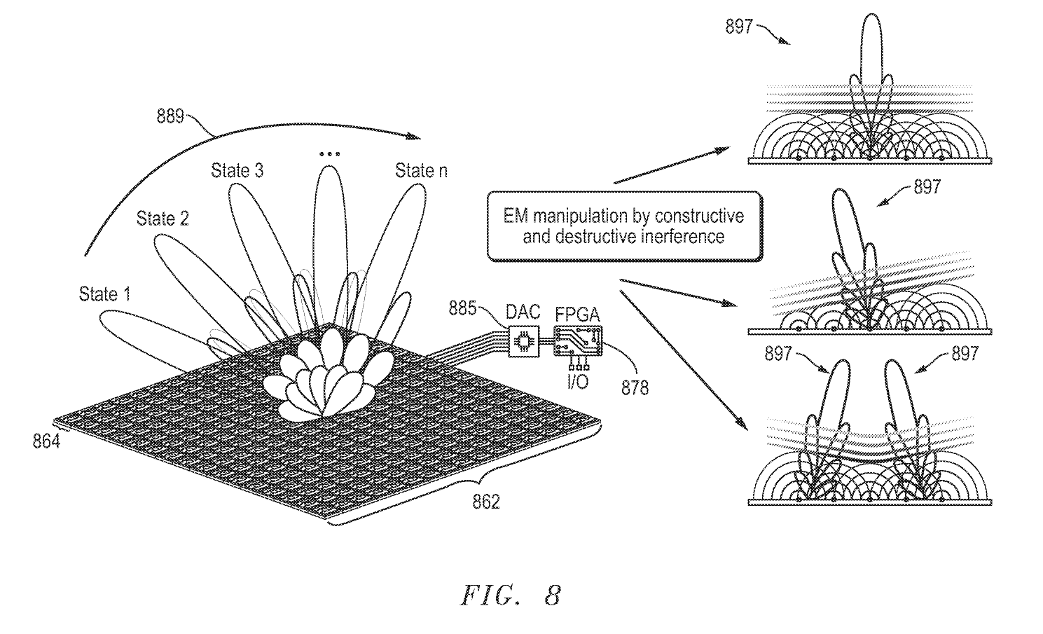

FIG. 8 is a graphic diagram of various emission states of a reconfigurable metasurface unit cell array 862 operated by a digital to analog converter (DAC) controller 885 and a field programmable gate array (FPGA) 878 operating as a metasurface controller according to an embodiment of the present disclosure. The DAC 885 and a metasurface controller such as an FPGA 878 may be formed on a printed circuit board with a power source or PMU and operatively coupled to the reconfigurable metasurface unit cell array 862. This DAC 885, metasurface controller such as an FPGA 878, and power source may be operatively coupled to contact pads of the reconfigurable metasurface unit cells of the reconfigurable metasurface unit cell array 862 in embodiments herein. FIG. 8 shows an example of the reconfigurable metasurface unit cell array 862 comprising an array of sixteen-by-sixteen reconfigurable metasurface unit cells that cooperate to direct and beamform a reflected EM wave of radiofrequency signals in a radiofrequency environment.

As described herein, the each of the reconfigurable metasurface unit cells 864 may be controlled via use of the FPGA 878 that controls power provided from a power source, such as PMU with battery or A/C power source, to each of the refractory heaters in order to change the corresponding metasurface reconfigurable split rings from amorphous state to a crystalline state or vice versa within the resonant structures of each reconfigurable metasurface unit cell 864. In the embodiment shown in FIG. 8, the metasurface PMU or PMU associated with the information handling system may provide power to the DAC 885 and an FPGA 878 that selectively applies the electrical pulses of power to refractory heaters for each individual metasurface reconfigurable split ring of each reconfigurable metasurface unit cell 864 within the reconfigurable metasurface unit cell array 862. The FPGA 878 may be any integrated circuit that contains the digital logic to actuate voltage pulses to each refractory heater by control of power from a power source or PMU to address contact pads for the refractory heaters such that the state of each metasurface reconfigurable split ring can be changed between an amorphous to a crystalline state or vice versa. By changing the state of each metasurface reconfigurable split ring can be changed between an amorphous to a crystalline state or vice versa, this alters the resonant structures of the reconfigurable metasurface unit cells 864 in order to create a transmission state and direction of the reflected EM waves off of the surface of the reconfigurable metasurface unit cell array 862. In an embodiment, a look-up table may be made accessible by the FPGA 878 that describes how the FPGA 878 is to activate each of the contact pads for refractory heaters of the reconfigurable metasurface unit cells 864 in order to create destructive or constructive interference across the reconfigurable metasurface unit cells 864 thereby creating the directionality and feed distance necessary to reflect the EM waves of radiofrequency signals towards a receiving device in focused beams 897 within the radiofrequency environment. Again, this transmission state and direction of the reflected EM waves off of the radiofrequency signals of the surface of the metasurface may include the use of constructive and destructive interference to create a focused beam 897 in any of a plurality of specific directions 889. As shown in FIG. 8, a direction 889 of the reflected EM waves may be controlled using phase shifting properties to change the direction 889 of the focused beam 897 or multiple focused beams 897 as shown by the individual states (e.g., “State 1,” “State 2,” “State 3,” and “State n”).

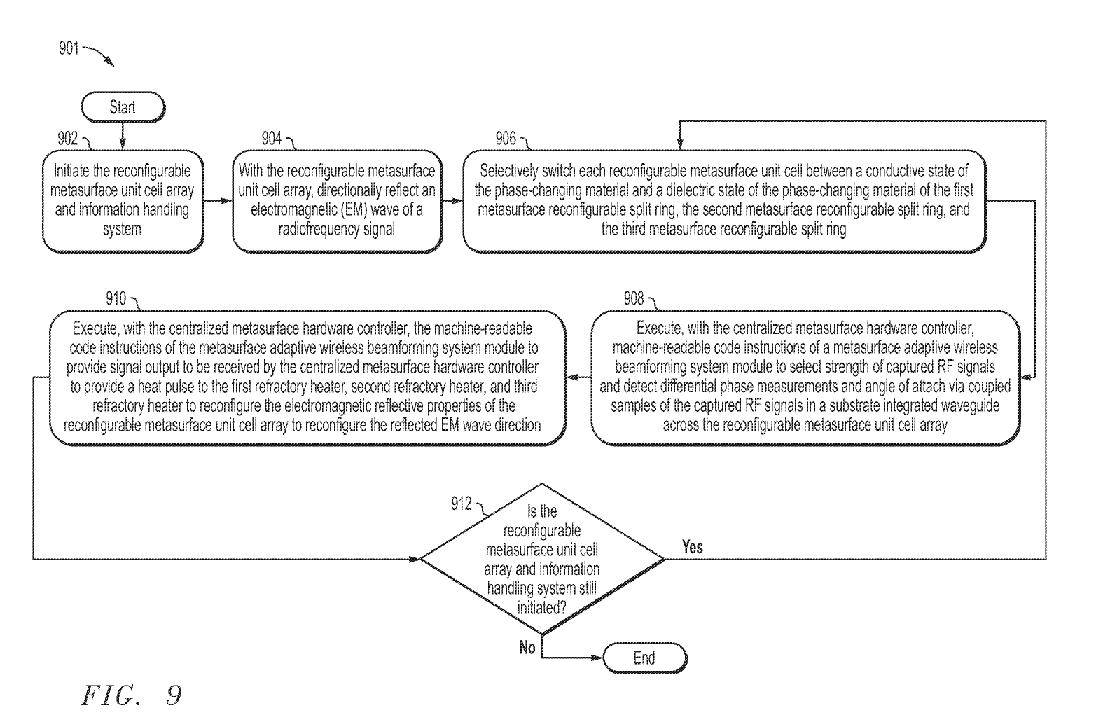

FIG. 9 is a flow diagram of a method 901 of detecting differential phase measurements from incident radiofrequency signals with substrate-integrated waveguides and detector elements of reconfigurable metasurface unit cells across a reconfigurable metasurface unit cell array according to an embodiment of the present disclosure. This method may be executed using the reconfigurable metasurface unit cell array described in connection with embodiments herein that includes reconfigurable metasurface unit cells with a substrate-integrated waveguide and RF coupling elements used to sample the RF signals incident to the surface of the reconfigurable metasurface unit cell array.

At block 902 the method 901 may include initiating the reconfigurable metasurface unit cell array and information handling system. In an embodiment where the reconfigurable metasurface unit cell array is operatively coupled to the information handling system, the initiation of the information handling system may cause the PMU of the information handling system to provide power to the reconfigurable metasurface unit cell array. In those embodiments where the reconfigurable metasurface unit cell array is a stand-alone device, the reconfigurable metasurface unit cell array may also be initiated by actuation of, for example, a power switch on the reconfigurable metasurface unit cell array to power the deployed reconfigurable metasurface unit cell array within the radiofrequency environment.

At block 904, the method 901 includes, with the reconfigurable metasurface unit cell array, directionally reflecting an electromagnetic (EM) wave of a radiofrequency signal. As described herein, the reconfigurable metasurface unit cell array includes a plurality of reconfigurable metasurface unit cells with reconfigurable resonant structures. In an embodiment, each of the plurality of reconfigurable metasurface unit cells include a first metasurface reconfigurable split ring, a second metasurface reconfigurable split ring, and a third metasurface reconfigurable split ring of a phase-changing material as reconfigurable resonant structures along with other resonant structures on the surface of each reconfigurable metasurface unit cell.

This allows one or more refractory heaters to, at block 906, selectively switch each reconfigurable metasurface unit cell between a conductive state of the phase-changing material and a dielectric state of the phase-changing material of the first metasurface reconfigurable split ring, the second metasurface reconfigurable split ring, and the third metasurface reconfigurable split ring. This is done via a heat pulse controlled by a centralized metasurface hardware controller from a first refractory heater, a second refractory heater, and a third refractory heater corresponding to the first metasurface reconfigurable split ring, the second metasurface reconfigurable split ring, and the third metasurface reconfigurable split ring as reconfigurable portions of resonant structures respectively. In an embodiment, each reconfigurable metasurface unit cell also comprises a substrate-integrated waveguide that includes a plurality of RF coupling elements to capture a portion of EM energy created from the EM wave of the RF signal incident on the reconfigurable metasurface unit cell. These RF coupling elements in the substrate-integrated waveguide detects these RF signals and are operatively coupled to send the detected RF signals to the centralized metasurface hardware controller. Activation of a greater number of RF coupling elements in the substrate-integrated waveguide may allow for a greater detected RF signal for transfer to the centralized metasurface hardware controller, but this may couple more of the EM energy from the reflected RF signals. This tradeoff may be selectable via activation of one or more of the RF coupling elements in the substrate-integrated waveguide depending on the strength of captured RF signal needed.

When the signal, or a portion thereof, is captured at the substrate-integrated waveguide, the method 901 further includes executing, with the centralized metasurface hardware controller, machine-readable code instructions of a metasurface adaptive wireless beamforming system module to detect differential phase measurements across the reconfigurable metasurface unit cell array at block 908. The RF signals incident on the surface of the reconfigurable metasurface unit cells are detected via RF coupling elements in the substrate-integrated waveguide and forwarded to the centralized metasurface hardware controller for signal processing. As described herein, this may include determination of differential phase measurements or may also include or be used to determine other characteristics of the RF signals such as the AoA of the signal, the field of the RF signal, the phase disparities in the signal, interference patterns within the signal, among other signal characteristics. Such characteristics of the RF signals may be used for a variety of purposes at the centralized metasurface hardware controller and may also require differing strength levels of the captured RF signals.

Thus, the centralized metasurface hardware controller may activate one or more contact pads for one or a plurality of RF coupling elements to be active in capturing the incident RF signals in the substrate-integrated waveguide depending on strength of captured signal needed in embodiments herein. In an embodiment, this captured RF signal from the RF coupling elements in the substrate-integrated waveguide is used as input to the centralized metasurface hardware controller executing the metasurface adaptive wireless beamforming system module for processing differential phase shift, AoA and other characteristics. Execution of the substrate-integrated waveguide may generate output describing how to reconfigure the reconfigurable resonant structures of the reconfigurable metasurface unit cells across the reconfigurable metasurface unit cell array for reflection of the RF signals such as at one or more angle-of-departure AoD directions.

Thus, at block 910, the method 901 includes the centralized metasurface hardware controller providing signal output to be used, such as by an FPGA controller, to provide voltage pulses for a heat pulse to the first refractory heater, second refractory heater, or third refractory heater to reconfigure the electromagnetic reflective properties of the reconfigurable metasurface unit cells across the reconfigurable metasurface unit cell array. This adjustment of the reconfigurable resonant structures of plural reconfigurable metasurface unit cells is orchestrated to reconfigure the reflected EM wave direction of reflected RF signals from the reconfigurable metasurface unit cell array. Again, this is pursuant to the data of the incident RF signals received via operation of the substrate-integrated waveguide.

The method 901 may continue to block 912 which includes determining if the reconfigurable metasurface unit cell array or the information handling system are still initiated. Where the reconfigurable metasurface unit cell array and information handling system are still initiated or whether the lid of the information handling system is still open, the method 901 proceeds to block 906 with the information handling system continuing to reflect RF waves using the substrate-integrated waveguide to determine characteristics of the RF wave and change the reflective properties of the reconfigurable metasurface unit cell array by altering the phase profile of the reconfigurable metasurface unit cells across the reconfigurable metasurface unit cell array. Where the reconfigurable metasurface unit cell array and information handling system are no longer initiated or the lid of the information handling system has been closed, the method 901 may end here.

The processes or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A reconfigurable metasurface unit cell array to directionally reflect an electromagnetic (EM) wave of a radiofrequency signal comprising:
a metasurface power management unit (PMU) to provide power to a metasurface hardware controller;
a plurality of reconfigurable metasurface unit cells, each of the plurality of reconfigurable metasurface unit cells having reconfigurable resonant structures of a phase-changing material including a first metasurface reconfigurable split ring and a second metasurface reconfigurable split ring disposed on a first dielectric substrate layer;
the metasurface hardware controller to control voltage from the metasurface PMU to generate a heat pulse from a first refractory heater or a second refractory heater disposed on a second dielectric substrate layer and aligned under the first dielectric substrate layer with the first metasurface reconfigurable split ring and the second metasurface reconfigurable split ring respectively to selectively switch between a conductive state and a dielectric state of the phase-changing material of at least one of the first metasurface reconfigurable split ring or the second metasurface reconfigurable split ring;
each reconfigurable metasurface unit cell comprising a substrate-integrated waveguide formed under the second dielectric substrate layer, the substrate-integrated waveguide includes a plurality of radiofrequency (RF) coupling elements in a shielded chamber to capture a portion of an incident RF signal received at the reconfigurable metasurface unit cells and report the captured incident RF signal to the metasurface hardware controller; and
the metasurface hardware controller executing machine-readable code instructions of a metasurface adaptive wireless beamforming system module to adjust phase shift of at least one reconfigurable metasurface unit cell via the reconfigurable resonant structures.

2. The reconfigurable metasurface unit cell array of claim 1 further comprising:
each reconfigurable metasurface unit cell including at least one non-reconfigurable resonant structure formed on the first dielectric substrate layer.

3. The reconfigurable metasurface unit cell array of claim 1 further comprising:
the substrate-integrated waveguide formed under the second dielectric substrate layer including a top metallization layer forming a top surface electrically coupled by a plurality of perimeter metal interconnect bars to a bottom metallization layer forming a bottom surface for the shielded chamber of the substrate-integrated waveguide.

4. The reconfigurable metasurface unit cell array of claim 1 further comprising:
each reconfigurable metasurface unit cell including a set of contact pads to operatively couple the first refractory heater and the second refractory heater to the metasurface PMU for a power source controlled by the metasurface hardware controller to provide power to the first refractory heater or the second refractory heater for the heat pulse.

5. The reconfigurable metasurface unit cell array of claim 1 further comprising:
the metasurface hardware controller executing machine-readable code instructions of a metasurface adaptive wireless beamforming system module to determine differential phase measurements of the captured incident RF signal across the reconfigurable metasurface unit cell array to determine control of a heat pulses to the refractory heaters at plural reconfigurable metasurface unit cells to adjust phase shifts of the plural reconfigurable metasurface unit cells to adjust directional beamsteering of a reflected RF signal from the surface of the reconfigurable metasurface unit cell array.

6. The reconfigurable metasurface unit cell array of claim 1, wherein the phase-changing material of each of the first metasurface reconfigurable split ring, the second metasurface reconfigurable split ring, and third metasurface reconfigurable split ring is selected from germanium telluride (GeTe), antimony telluride (SbTe), or chalcogenide (GeSbTe) that selectively switch between the conductive state and the dielectric state when the heat pulse is applied.

7. The reconfigurable metasurface unit cell array of claim 1 further comprising:
the plurality of RF coupling elements are formed into U-shaped segments formed around refractory heater metal interconnects electrically coupling the first refractory heater and the second refractory heater to a plurality of connection pads, wherein the refractory heater metal interconnects are disposed through the shielded chamber of the substrate-integrated waveguide to electromagnetically couple the incident RF signal to the plurality of RF coupling elements.

8. The reconfigurable metasurface unit cell array of claim 1 further comprising:
the RF coupling elements comprising a first RF coupling element and a second RF coupling element that each have different thicknesses and are activated depending on the strength of the captured incident RF signal.

9. A method of detecting a radiofrequency (RF) signal incident across a reconfigurable metasurface unit cell array comprising:
directionally reflecting an electromagnetic (EM) wave of the RF signal with the reconfigurable metasurface unit cell array, wherein the reconfigurable metasurface unit cell array includes a plurality of reconfigurable metasurface unit cells each having plural reconfigurable resonant structures of a phase-changing material, including a first metasurface reconfigurable split ring and a second metasurface reconfigurable split ring;
selectively switching at least one reconfigurable resonant structure at a reconfigurable metasurface unit cell between a conductive state and a dielectric state of the phase-changing material of the first metasurface reconfigurable split ring or the second metasurface reconfigurable split ring via a heat pulse from a first refractory heater or a second refractory heater corresponding to the first metasurface reconfigurable split ring or the second metasurface reconfigurable split ring respectively, where the heat pulse is controlled by a metasurface hardware controller;
coupling a portion of EM energy from the RF signal incident on a surface of the reconfigurable metasurface unit cell array via an RF coupling element electromagnetically coupled with a refractory heater metal interconnect within a shielded chamber of a substrate-integrated waveguide formed below the second dielectric substrate layer of the reconfigurable metasurface unit cell to report a captured incident RF signal to the metasurface hardware controller, wherein the refractory heater metal interconnect electrically couples the first refractory heater or the second refractory heater to a contact pad of the reconfigurable metasurface unit cell; and
executing, with the metasurface hardware controller, machine-readable code instructions of a metasurface adaptive wireless beamforming system module to detect the captured incident RF signals across the reconfigurable metasurface unit cell array and determine a heat pulse to the first refractory heater or the second refractory heater to reconfigure electromagnetic reflective properties of plural reconfigurable metasurface unit cells via the reconfigurable resonant structures to reconfigure a direction of a reflected RF signal by the reconfigurable metasurface unit cell array.

10. The method of claim 9, wherein the reconfigurable metasurface unit cell array is formed on an outer surface of a display chassis cover of the information handling system.

11. The method of claim 9, wherein the substrate-integrated waveguide formed under the second dielectric substrate layer includes a top metallization layer forming a top surface electrically coupled by a plurality of perimeter metal interconnect bars to a bottom metallization layer forming a bottom surface for the shielded chamber of the substrate-integrated waveguide.

12. The method of claim 9, wherein the phase-changing material of each of the first metasurface reconfigurable split ring, the second metasurface reconfigurable split ring, and third metasurface reconfigurable split ring is selected from germanium telluride (GeTe), antimony telluride (SbTe), or chalcogenide (GeSbTe) that selectively switch between the conductive state and the dielectric state when heat is applied.

13. The method of claim 9 further comprising:
the reconfigurable metasurface unit cell includes plural RF coupling elements in the substrate-integrated waveguide that each have different thicknesses and are activated depending on the strength of the captured incident RF signal.

14. A reconfigurable metasurface unit cell array to directionally reflect an electromagnetic (EM) wave of a radiofrequency signal comprising:
a metasurface power management unit (PMU) to provide power to a metasurface hardware controller;
a plurality of reconfigurable metasurface unit cells, each of the plurality of reconfigurable metasurface unit cells having a non-reconfigurable resonant structure and reconfigurable resonant structures of a phase-changing material, including a first metasurface reconfigurable split ring and a second metasurface reconfigurable split ring, disposed on a first dielectric substrate layer;
the metasurface hardware controller to control each reconfigurable metasurface unit cell to selectively switch between a conductive state and a dielectric state of the phase-changing material of the first metasurface reconfigurable split ring or the second metasurface reconfigurable split ring via voltage from the metasurface PMU to generate a heat pulse from a first refractory heater or a second refractory heater on a second substrate dielectric layer and under the first dielectric substrate layer, where the first refractory heater and the second refractory heater are aligned under the first metasurface reconfigurable split ring and the second metasurface reconfigurable split ring respectively;
each reconfigurable metasurface unit cell comprising a substrate-integrated waveguide that formed under a second dielectric substrate layer and includes a plurality of radiofrequency (RF) coupling elements in a shielded chamber to capture a portion of EM energy coupled from an incident RF signal received at the reconfigurable metasurface unit cells to report the captured incident RF signal to the centralized metasurface hardware controller; and
the metasurface hardware controller executing machine-readable code instructions of a metasurface adaptive wireless beamforming system module to determine differential phase measurements of the captured incident RF signal across the reconfigurable metasurface unit cell array to determine control of a heat pulse to the first refractory heater or the second refractory heater to adjust phase shift at least one reconfigurable metasurface unit cell via the reconfigurable resonant structures.

15. The reconfigurable metasurface unit cell array of claim 14 further comprising:
the substrate-integrated waveguide formed under a second dielectric substrate layer including a top metallization layer forming a top surface electrically coupled by a plurality of perimeter metal interconnect bars to a bottom metallization layer forming a bottom surface for the shielded chamber of the substrate-integrated waveguide.

16. The reconfigurable metasurface unit cell array of claim 14 further comprising:
each reconfigurable metasurface unit cell including a set of contact pads to operatively couple the first refractory heater and the second refractory heater to the metasurface PMU for a power source controlled by the metasurface hardware controller to provide power to the first refractory heater or the second refractory heater for the heat pulse.

17. The reconfigurable metasurface unit cell array of claim 14 further comprising:
each reconfigurable metasurface unit cell including a set of contact pads to operatively couple the RF coupling elements in the substrate-integrated waveguide to report the captured incident RF signal to the metasurface hardware controller.

18. The reconfigurable metasurface unit cell array of claim 14, wherein the phase-changing material of each of the first metasurface reconfigurable split ring, the second metasurface reconfigurable split ring, and third metasurface reconfigurable split ring is selected from germanium telluride (GeTe), antimony telluride (SbTe), or chalcogenide (GeSbTe) that selectively switch between the conductive state and the dielectric state when the heat pulse is applied.

19. The reconfigurable metasurface unit cell array of claim 14 further comprising:
the plurality of RF coupling elements are formed into U-shaped segments formed around refractory heater metal interconnects electrically coupling the first refractory heater and the second refractory heater to a plurality of connection pads, wherein the refractory heater metal interconnects are disposed through the shielded chamber of the substrate-integrated waveguide to electromagnetically couple the incident RF signal to the plurality of RF coupling elements.

20. The reconfigurable metasurface unit cell array of claim 14 further comprising:
the plurality of RF coupling elements are activated depending on the strength of the captured incident RF signal.
